(19) United States
(12) Patent Application Publication
(10) Pub. No.: US 2024/0374358 A1
(43) Pub. Date: Nov. 14, 2024

(54) SCREW RETAINED DENTAL RESTORATION AND METHOD OF MAKING SAME

(71) Applicant: James R. Glidewell Dental Ceramics, Inc., Newport Beach, CA (US)

(72) Inventors: David C. Leeson, Laguna Beach, CA (US); Marco A. Jokada, Diamond Bar, CA (US); Kenad Destanovic, Mission Viejo, CA (US); Fernando Vera, Fountain Valley, CA (US); Vaheh Golestanian Nemagrdi, Orange, CA (US); Fazan Akhter, Newport Beach, CA (US); Ivan Ivlev, Newport Beach, CA (US)

(73) Assignee: James R. Glidewell Dental Ceramics, Inc., Newport Beach, CA (US)

(21) Appl. No.: 18/314,678

(22) Filed: May 9, 2023

(51) Int. Cl. A61C 13/00

(52) U.S. Cl. CPC A61C 13/0004; A61C 13/0006; A61C 13/34

(57) ABSTRACT

A physical preform suitable for a screw retained dental restoration (“SRR”) includes a sintered preform and an insert receiving region within at least a portion of the sintered preform. A computer-implemented method of providing a screw retained dental restoration includes receiving a virtual restoration mode and generating one or more virtual spiral toolpaths corresponding to a virtual restoration shape of the virtual restoration model. A computer-implemented method of correcting preform placement during milling includes probing one or more surface points of a preform mounted to a milling machine using a grinding bur of the milling machine and determining one or more preform alignment parameters based on a distance traveled by the grinding bur to the one or more surface points.

### TECHNICAL FIELD

The technical field relates to dental restorations.

### BACKGROUND

Ceramic materials known for use in the field of dentistry provide high strength restorations such as crowns, bridges, full restoration teeth, and the like. Some ceramic materials have flexural strength values exceeding 800 MPa when fully sintered, resulting in restorations that are resistant to chipping, breakage and wear.

Dental restorations created by computer assisted design processes may be milled by CAM processes from porous ceramic materials in the green or pre-sintered ceramic stage, using an enlargement factor to accommodate reduction in overall size upon heating to full density. After milling, the porous restoration design is sintered to full density to produce a final restoration.

Milling is often performed on blocks of ceramic material called preforms. Preforms are typically variously sized and shaped as a block of ceramic material that can be mounted on a mill for milling into a restoration. Disadvantageously, conventional preforms may not be suitable for shaping into screw retained dental restorations such as screw retained crowns and the like due to internal structural features and other components used with screw retained dental restorations. Accordingly, the separate steps of milling the porous ceramic dental design and sintering the milled shape to form the final screw retained dental restoration may preclude dentists from making chairside ceramic screw retained crown restorations, increasing the amount of time a patient must wait for to receive and have their screw retained dental restoration installed.

Mills in field were not made with a screw retaining crown/restoration application in mind, which requires precise knowledge of crown screw position and orientation (Pose). Current systems can introduce errors in material holder and block manufacturing tolerances.

### SUMMARY

A physical preform suitable for a screw retained dental restoration (“SRR”) is disclosed. The physical preform can include a sintered preform and an insert receiving region within at least a portion of the sintered preform.

A computer-implemented method of providing a screw retained dental restoration is disclosed. The computer-implemented method can include: receiving a virtual restoration model; and generating one or more virtual spiral toolpaths corresponding to a virtual restoration shape of the virtual restoration model.

A computer-implemented method of correcting preform placement during milling is disclosed. The computer-implemented method can include: probing one or more surface points of a preform mounted to a milling machine using a grinding bur of the milling machine; and determining one or more preform alignment parameters based on a distance traveled by the grinding bur to the one or more surface points.

### BRIEF DESCRIPTION OF THE DRAWINGS

FIG. 1 shows a top perspective view of a graphic representation of a preform in some embodiments.

FIG. 2(a) shows a perspective view of a graphic representation of a physical insert in some embodiments. FIG. 2(b) shows a top view of a graphic representation of a physical insert in some embodiments.

FIG. 3(a) shows a top perspective view of a graphic representation of a preform and internal features in some embodiments. FIG. 3(b) shows a side cross sectional view of a graphic representation of a preform and internal features in some embodiments. FIG. 3(c) shows a bottom perspective view of a graphic representation of a preform in some embodiments. FIG. 3(d) shows a top view of a graphic representation of a preform and internal features in some embodiments. FIG. 3(e) shows a top view of a graphic representation of a preform and internal features in some embodiments.

FIG. 4 shows an illustration of dimensions of a preform.

FIG. 5 shows a side view of a graphic representation of a preform and internal features in some embodiments.

FIG. 6(a) shows a bottom view of a graphic representation of a preform affixed to a mandrel in some embodiments. FIG. 6(b) shows a top view of a graphic representation of a preform attached to mandrel in some embodiments.

FIG. 7 shows a perspective view of a graphic representation of a physical insert affixed to a preform in some embodiments.

FIG. 8(a) shows a perspective view of a graphic representation of scan data having an installed scan body in some embodiments. FIG. 8(b) shows a perspective view of a graphic representation of scan data with a virtual scan body model in some embodiments. FIG. 8(c) shows a cross section view of a graphic representation of a restoration design with prohibited regions some embodiments.

FIG. 9(a) shows a perspective view of a graphic representation of a virtual restoration design bottom surface in some embodiments. FIG. 9(b) shows a shows a perspective view of a graphic representation of a preform in some embodiments.

FIG. 10 shows a cross section view of a graphic representation of a virtual preform, virtual crown, and virtual insert system in some embodiments.

FIG. 11(a) and FIG. 11(b) show a side view of a graphic representation of nesting in some embodiments.

FIG. 12 shows a graphic representation of a spiral virtual toolpath in some embodiments.

FIG. 13(a) through FIG. 13(1) show screenshots of a graphic representation of one or more constant cusp parameters in some embodiments.

FIG. 14(a) through FIG. 14(d) shows graphic representations of a sprue reduction toolpath.

FIG. 15 shows a graphical representation of a mandrel in some embodiments.

FIG. 16 shows a side view of a graphic representation of a physical preform secured to a mandrel having a physical insert in some embodiments.

FIG. 17 shows a perspective view of a graphic representation of a physical mandrel in some embodiments.

FIG. 18(a) through FIG. 18(c) shows different views of graphic representations of a physical preform and physical stem in some embodiments.

FIG. 19 shows a bottom view of a graphic representation of a mandrel with a preform attached in some embodiments.

FIG. 20(a) through FIG. 20(e) show different views of graphic representations of a preform and determining alignment on a mill.

FIG. 21 (a) shows a perspective view of a graphic representation of a preform with an insert and a restoration in some embodiments. FIG. 21 (b) shows a perspective view of a graphic representation of milling in some embodiments.

FIG. 22 shows a side view of a graphic representation of a physical restoration having a sprue and an attached insert in some embodiments.

FIG. 23 shows a diagram of a system in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

One or more features in some embodiments can allow a dental professional to generate and mill a screw retained dental restoration (“SRR”) for a particular dental implant system from a sintered preform block in a dental office. In some embodiments, the physical SRR can also include an affixed physical insert corresponding to the particular dental implant system. The restorations described herein can be any type of dental restoration, including but not limited to crowns, bridges, full restoration teeth, and the like.

In some embodiments, the dental professional can select a dental implant system to use for the SRR based on the patient's dental situation. The dental professional can surgically implant an analog into a patient's jaw and affix a scan body for the selected dental implant system into the analog and obtain a digital scan of the scan body and at least a portion of the patient's dentition. The dental professional can, through a computer interface, request a SRR and provide the digital scan data and selected dental implant system. The SRR can be virtually generated and virtually nested within a virtual preform that includes a virtual stem. The virtual SRR can include internal SRR features such as a screw receiving region and an insert receiving region. The virtual SRR can also have an attached virtual insert model in its insert receiving region, one or more virtual toolpaths, and a virtual sprue via the virtual preform stem. The dental professional can place the physical sintered preform in a mill, which can optionally perform alignment detection to determine one or more alignment parameters. The mill can then mill the virtual SRR in a milling machine in the dental office via CAD/CAM, in some embodiments, to provide a sintered physical SRR having screw receiving region and an insert in its insert receiving region. The dental professional can install the physical SRR into the analog previously implanted in the jaw of the patient, drop a screw through the screw receiving region of the physical SRR, and tighten the screw into the analog, thereby affixing the physical SRR to the analog. The dental professional can fill the screw receiving region with dental material and detach any sprue.

The dental office can also be referred to as “chairside”. Alternatively, the dental facility can be a dental laboratory. The dentist's office or dental laboratory can include a milling machine such as a FastMill™ by Glidewell Laboratories or other type of milling machine suitable for shaping/milling dental restorations. In some embodiments, the milling machine is portable to fit within the dental office. The dentist's office can also include a computer system that can run CAD/CAM or other type of dental design software such as FastDesign or FastDesign.io and can be used to submit the request to generate the SRR, as well as display one or more virtual components. The dental office computer system can also communicate with the milling machine by either wired connection or over a wireless network or other communication channel known in the art. One or more sintered preforms for SRRs can be fabricated in a dental laboratory and provided to the dental professional prior to milling the SRR. The one or more sintered preforms can each have a physical insert pre-affixed to the sintered preform, as well as a stem. The sintered preforms can also already have a desired shade.

### Sintered Preform

One example of a physical sintered preform and method of making the same can be found in U.S. Pat. No. 11,045,291 to Leeson, et al., the entirety of which is hereby incorporated by reference. The physical sintered preform can be machined in some embodiments using a milling machine or other type of device to shape the physical preform into a physical restoration.

In some embodiments, the dimensions provided for the preform (including the preform body, stem, and any other regions/features) are after the preform has been sintered. Accordingly, an enlargement factor may be applied to the preform dimensions provided herein for pre-sintering dimensions. The enlargement factor can vary. In some embodiments, the enlargement factor can be in the range from 1.19 to 1.235, including the endpoints of the range. In some embodiments, the enlargement factor can be in any suitable range to account for sintering.

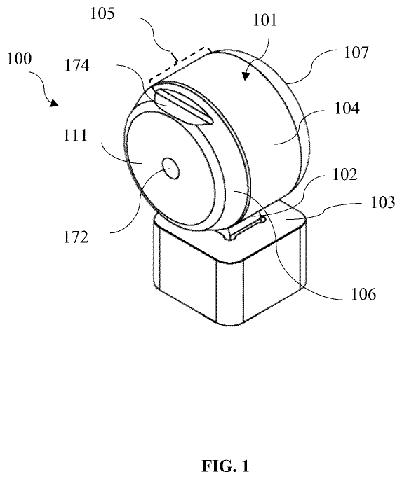

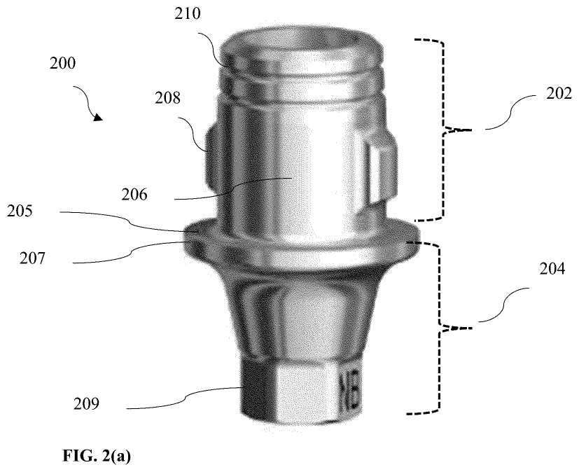

In some embodiments, the physical sintered preform can include a preform body and a preform stem region (“stem”), which can extend from the preform body. In some embodiments, the preform body can include a top end region, a center portion, and a bottom end region. As can be seen in FIG. 1, a preform 100 with a preform body 101 can include a curved outer surface 104 and a center portion 105 between a bottom end region 107 and a top end region 106. In some embodiments, a stem 102 can project away from the curved outer surface 104 of the cylindrical body, and extend to an attaching member 103 for direct or indirect attachment to a shaping machine such as a dental restoration milling machine, for example. In some embodiments, the preform body 101 can be circular-cylindrical shaped. Other suitable shapes can be used for the preform body.

In some embodiments, the preform body can have substantially flat end faces and a uniform cross-sectional diameter or width throughout the length of the body. Alternatively, top and bottom end regions 106, 107 taper to comprise a top end face 111 and a bottom end face (not shown) with smaller cross-sectional diameters or widths than the center portion 105 in some embodiments. Tapered top and/or bottom end portions may comprise a shaped edge between the preform outer surface 104 of the center portion and an end face (e.g., top/bottom end face). The curved outer surface 104 of the cylindrical body center portion 105 can be substantially smooth, with the center portion 105 having a uniform outer diameter between top and bottom ends. In some embodiments, preform 100 can include a screw receiving opening 172 on a top end face 111 of the top end region 106. In some embodiments, the preform 100 can include a ledge 174.

In some embodiments, the sintered preform can include one or more internal structures specific to SRRs, such as an insert receiving region and a screw receiving region (such a sintered preform can also be referred to as an “SRR preform”). In some embodiments, the physical sintered preform can include an insert receiving region within at least a portion of the sintered preform. The insert receiving region can be shaped to receive at least a portion of an insert for a dental implant system (“insert”). In some embodiments, the insert receiving region can be substantially cylindrical in shape. In some embodiments, the insert receiving region can be any shape suitable for at least a portion of the insert receiving region to receive at least a portion of an insert that is part of one or more dental implant systems. In some embodiments, the insert receiving region can be a cavity in the preform having an opening to connect with the screw receiving region.

In some embodiments, the insert receiving region can include a top insert receiving region opening and a bottom insert receiving region opening. In some embodiments, the top insert receiving region opening can be closest to the top end of the preform body. The bottom insert receiving region opening can be on the bottom receiving region of the sintered preform and can receive an insert. The top insert receiving region opening can receive a dental implant system screw. In some embodiments the top insert receiving region opening diameter/length can be less than the bottom insert receiving region opening.

In some embodiments, the insert receiving region can be shaped and dimensioned to receive a physical insert. A physical insert can include an interfacing region and a connection region. The interfacing region can be suitable to insert into the insert receiving region. In some embodiments at least a portion of the interfacing portion of the physical insert is affixed within at least a portion of the insert receiving region of the sintered preform. In some embodiments, the entire interfacing region is affixed within the insert receiving region of the preform. In some embodiments, the interfacing region can include a shank. In some embodiments, the shank can include one or more retention/locking features. Accordingly, the interfacing region can be a shank or at least a portion of a shank of a physical insert in some embodiments and/or any locking features. In some embodiments, the one or more retention/locking features can include, for example, lobes, threads, etc. Lobes can include protrusions from the shank in some embodiments. In some embodiments, one or more retention/locking features can include anti-rotational features. Anti-rotational features can include, without limitation, a flat wall, L-cut, key, double key, lobe, double lobe, trilobe. Other retention features can be used and/or additional retention features can be present in some embodiments. The one or more retention features can affix the physical insert into the insert receiving region such that movement is reduced and/or restricted to prevent/limit the physical insert from rotating and/or sliding out of the insert receiving region in some embodiments. In some embodiments, the shank can have a diameter such that the shank diameter can fit within the insert receiving region. In some embodiments, the insert receiving region is shaped and sized such that the insert shank and any retention feature maximum diameter of the physical insert can fit within the insert receiving region. In some embodiments, the shank can have a diameter less than the diameter of the bottom end opening of the insert receiving region. In some embodiments, the shank and any retention feature maximum diameter can be less than the diameter of the bottom end opening of the insert receiving region. As an example, in some embodiments, the shank diameter can be from 2.7 mm to 3.85 mm, including the endpoints of the range. As an example, in some embodiments, the shank diameter can be 2.7 mm, 3.05 mm, 3.25 mm, or 3.85 mm. Other shank diameters can be utilized. In some embodiments the physical insert can include titanium. In some embodiments the physical insert can include a Cobalt-Chromium material. Other materials can be used for the physical insert. One example of a physical insert in some embodiments can include physical inserts used in the Hahn Implant System™. Other physical inserts belonging to other dental implant systems can also be used. In some embodiments, the physical insert can be made using a screw machine.

In some embodiments the physical insert can be pre-cemented on the interfacing region. In some embodiments the preform interfacing portion can be surrounded by at least a portion of the sintered preform. In some embodiments, the entire interfacing region can be surrounded by sintered preform material of the insert receiving region after being inserted into the sintered preform.

The connection region can be suitable to interface with an implant system installed in a patient's dentition, for example. The connecting region can include a ring around the insert that connects with the interfacing region of the insert. The ring can have a diameter larger than the diameter of the shank in some embodiments. The ring can include a ring shelf which can rest against the sintered preform after the insert is affixed into the insert receiving region.

The connection region can taper from its ring into a connecting end that connects to an analog, such as one installed in a patient's jaw, and can include one or more implant specific connecting features. In some embodiments, the connecting end of the physical insert can include one or more anti-rotational features and/or optionally one or more locking features. For example, in some embodiments, a cross section of the connecting region of the physical insert can include a polygon shaped inserting region that can be fit into a corresponding polygon shaped cross section of a receiving region of the implant. Any polygon shape can be used. In some embodiments, the polygon shape can include but not be limited to hexagons, octagons, pentagons, etc. Once the polygon shaped inserting region of the connecting region is inserted into the insert receiving region of the implant, the physical insert can be prevented from rotating in some embodiments. In some embodiments, the physical insert can be hollow inside, allowing a screw to pass through the interfacing region and connection region. A bottom-most portion of the connection region can include an internal shelf that can contact a screw head. The implant analog can include threads so that the threaded portion of the screw can be tightened into the implant analog, with the screw head pulling and affixing the SRR into the implant due to the screw head contacting the internal shelf region of the insert connection region.

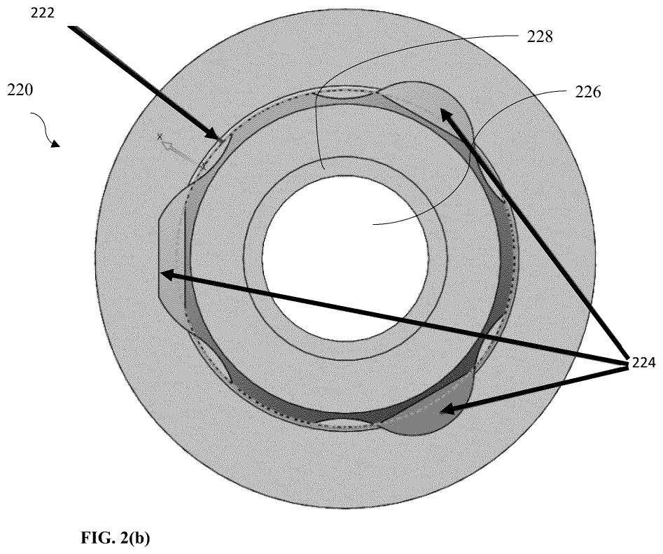

FIG. 2(a) illustrates one example of a physical insert 200 in some embodiments. The physical insert 200 can include an interfacing region 202 and a connection region 204, for example. The connection region 204 can include a ring 207 with ring shelf 205 and a connecting end 209. The interfacing region 202 can include a shank 206. The shank 206 can include one or more retention features such as, for example, lobes such as lobe(s) 208 and/or retention grooves 210. The interfacing region 202 of the physical insert 200 can be inserted into and affixed to an insert receiving region of a physical sintered preform, for example in some embodiments. In some embodiments, the interfacing region 202 can have a length based on the dental implant system type chosen. In some embodiments, the interfacing region 202 can have a length of 4.5 mm. Other suitable lengths for the interfacing region 202 can be used. FIG. 2(b) illustrates another view of a physical insert 220 having a shank 222 and retention features such as lobes 224. The connection region 204 can be placed into a physical analog of an implant system. The physical analog can be installed in a patient's jaw, for example. The physical insert 220 can include a hollow channel 226 allowing passage of a screw. A bottom of a connection region of the physical insert 220 can include an internal shelf 228 to contact the screw head, so that tightening of the screw into the implant analog pulls and affixes the physical insert 220 along with the SRR into the implant analog.

In some embodiments the bottom insert receiving region opening diameter of the sintered preform can be equal to a shank diameter of the insert. In some embodiments the bottom insert receiving region opening diameter of the sintered preform can be greater than the shank diameter of the insert. In some embodiments the bottom insert receiving region opening diameter of the sintered preform can be less than the shank diameter of the insert. In some embodiments, the insert receiving region can be shaped to accommodate one or more protrusions from the shank to affix the insert within the insert receiving region. In some embodiments, the bottom insert receiving region opening diameter can be equal to a maximum protrusion diameter. In some embodiments, the bottom insert receiving region opening diameter can be greater or less than a maximum protrusion diameter. In some embodiments, the insert receiving region can include lobes or indentations to receive/accommodate any protrusions from the insert shank. The protrusions can be arranged and designed to limit or prevent rotation and/or movement of the insert within the insert receiving region of the sintered preform. In some embodiments the insert receiving region can be sized account for a cement gap. In some embodiments the cement gap can include space for cement to affix the insert within the insert receiving region. In some embodiments the cement gap can include 0.02 mm. Other cement gap values can be used if necessary to secure at least a portion of the insert in at least a portion of the insert receiving region. A cement gap may not always be necessary, however, as the insert can stay in place due to mechanical friction between the insert shank and/or protrusion(s) and insert receiving region walls. In some embodiments, the insert receiving region diameter can be smaller than the diameter of the insert.

In some embodiments, the physical preform can further include a screw receiving region within at least a portion of the sintered preform on an opposite end of the insert receiving region of the sintered preform. In some embodiments the screw receiving region can be shaped to allow a screw to pass through the screw receiving region. In some embodiments, the screw receiving region can be substantially cylindrical in shape. In some embodiments, the screw receiving region can be any shape suitable to receive a screw that is part of one or more dental implant systems. In some embodiments the screw receiving region can include a screw receiving region opening on a side opposite the insert region side of the sintered preform to receive a screw. The screw receiving region can be accessible by the screw receiving region opening in the top end region of the preform body. In some embodiments the screw receiving region of the sintered preform corresponds to a screw receiving region of the SRR.

In some embodiments, the screw receiving region and the insert receiving region are connected internally within the sintered preform and form a passage or channel through the preform from the top end region to the bottom end region of the preform. Each end of the passage/channel can be open. The passage/channel can accommodate a screw from a dental implant system. The top region of the insert receiving region can include an opening sufficient in diameter to allow passage of a dental implant system screw. In some embodiments, the top region of the insert receiving region opening can be smaller in diameter than the diameter of the insert. In some embodiments the screw receiving region can be surrounded by sintered preform material. In some embodiments, the screw receiving region and the insert receiving region can be the same or of a similar shape. In some embodiments, the screw receiving region and the insert region can substantially cylindrical. In some embodiments, the screw receiving region and insert receiving region can be of a different shape. In some embodiments the at least portion of the insert can be locked in place in the insert receiving region after insertion. In some embodiments the screw receiving region diameter can be less than the insert receiving region diameter. A smaller diameter screw receiving region than the insert receiving region allows an insert to remain within the insert receiving region and not pass into the screw receiving region. The largest diameter of a screw in a dental implant system can smaller than the diameter of the screw receiving region, which can be smaller than the diameter of an insert. This can allow, in some embodiments, the dental implant system screw pass through the screw receiving region and into the insert.

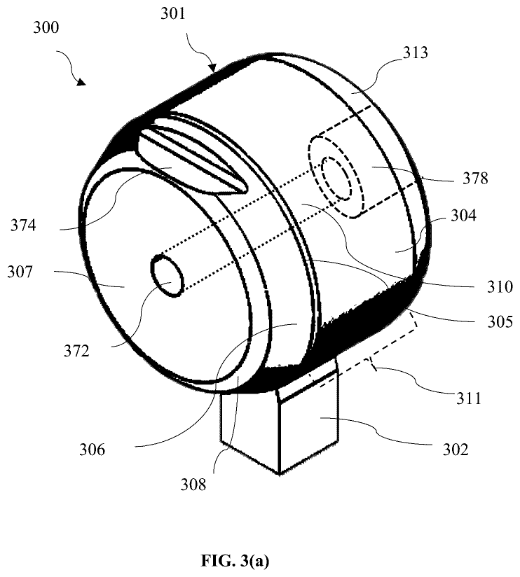

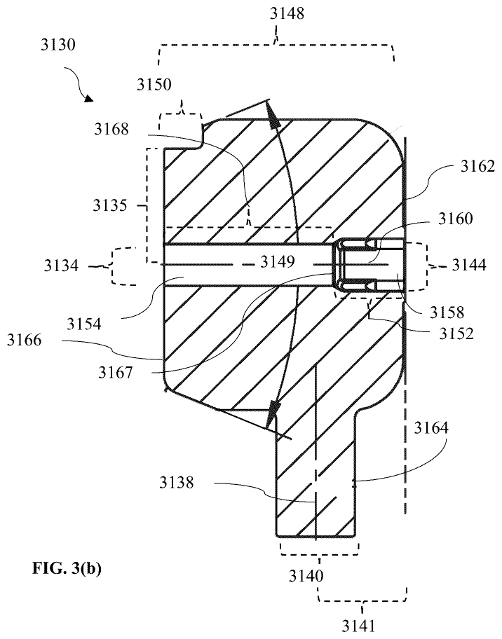

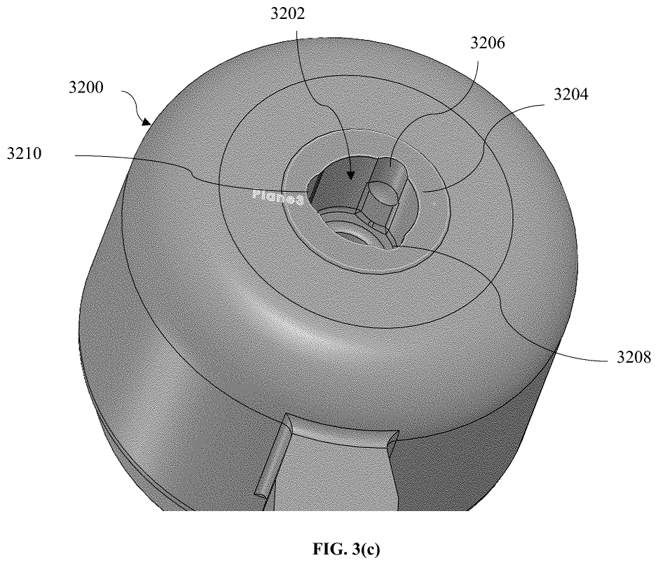

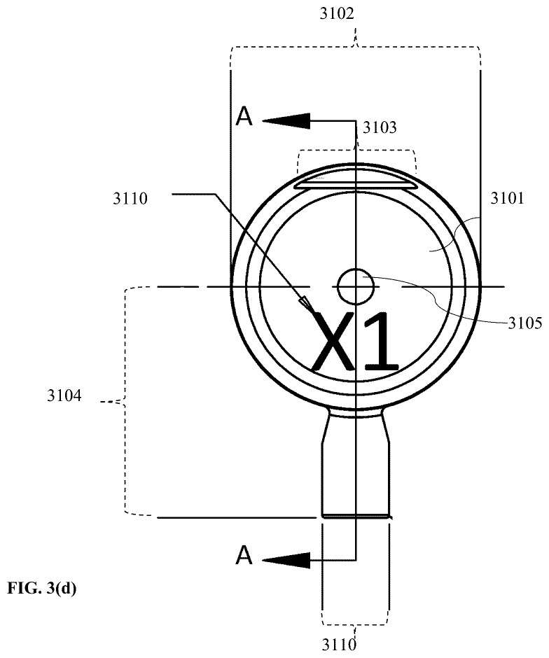

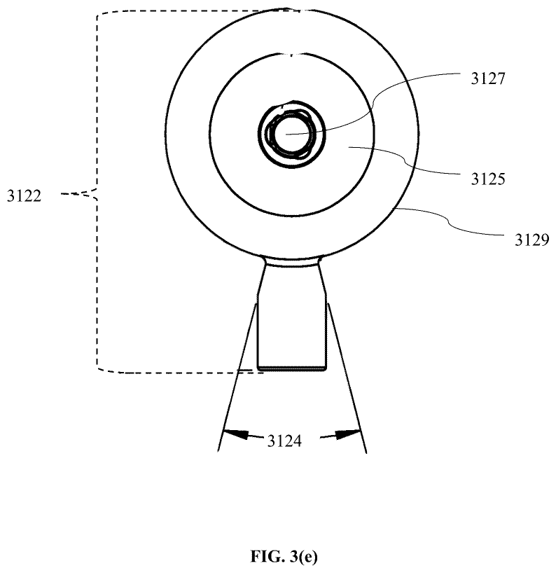

With reference to an embodiment illustrated in FIG. 3(a), a machinable physical preform 300 can include a preform body 301 and a preform stem 302 that projects from the preform body 301, a screw receiving region 310 and an insert receiving region 378. In some embodiments, the preform body 301 can include a top end region 305, a center portion 311, and a bottom end region 313. In some embodiments, the top end region 305 can include a first filleted edge 306 between an outer surface 304 of the center portion 311 and a top end face 307. In some embodiments, a second filleted edge 308 can surround the top end face 307.

In some embodiments, the screw receiving region 310 can include a screw receiving opening 372 can have a center corresponding to or substantially near a top end face 307 center. However, other suitable locations for the screw receiving opening 372 can be used to accommodate different preform shapes and dimensions and/or different screw shapes and dimensions. For example, in some embodiments, the screw receiving opening 372 center can be off-center with respect to the top end face center. In some embodiments, the preform 300 can include an edge 374 within a tapered region of the top end region 306 such as the first filleted edge 306 and the second filleted edge 308. In some embodiments, the edge 374 can provide an interface for placing and/or aligning the preform 300 during milling. In some embodiments, the edge 374 can extend from the top end face 307 and into at least a portion of the first filleted edge 306. Other suitable locations of the edge 374 can be used to accommodate placement, alignment, and/or holding the preform 300 during milling.

For example, as illustrated in the figures, in some embodiments, the top end face 307 can include the screw receiving region opening 372 to provide access to the screw receiving region 310. In some embodiments, the shape of the screw receiving region opening 372 can be substantially the same size and shape as a cross section of the screw receiving region 310. In some embodiments, the screw receiving region 310 can extend through at least a portion of the preform body 301 and be accessible from the top end face 307. In some embodiments, the screw receiving region 310 can extend within at least a portion of the preform body 301 up to an insert receiving region 378. In the embodiment illustrated FIG. 3(a), preform body tapers to a bottom end region 313 that can include a filleted edge between the bottom end face (not illustrated) and the preform body outer surface 304. In some embodiments, the insert receiving region 378 can extend within at least a portion of the preform body 301 and connect to an insert receiving region opening 378 on the bottom end region 313. In some embodiments, at least a portion of the first filleted edge 306 and at least a portion of the second filleted edge 308 can include an edge 374. In some embodiments, the edge 374 can be used for determining alignment of the preform 300 during milling.

In some embodiments, the preform body 301 can be any shape. In some embodiments, the preform body 301 can be in the shape of a cylinder or other shape suitable for milling a dental restoration. In some embodiments, the center portion 311 can be in the shape of a cylinder, as depicted in the Figures. In some embodiments, other suitable shapes may be used herein. Alternatively, the center portion 311 can be any suitable shape, including but not limited to, for example, an ellipsoid cylinder, a polyhedron, curved polyhedron, a cylinder with flattened surfaces, a cube, a cube with rounded edges, and the like in some embodiments.

FIG. 3(b) illustrates a cross sectional side view of a preform body 3130 in some embodiments. The preform body 3130 is provided for illustrative purposes only. Other shapes and dimensioned preform bodies can be used in some embodiments. The preform body 3130 can have a ledge depth 3150 that can be suitable for detecting alignment/orientation/positioning of the preform body 3130 to/on a milling machine in some embodiments. In some embodiments, the ledge depth 3150 can be, for example, in the range from 2.125 mm to 2.375 mm, including the range endpoints. Other values can be used for the ledge depth 3150. In some embodiments, the preform body 3130 can include a body region width 3148 that can be suitable for including at least a portion of a dental restoration such as a crown or other type of dental restoration. In some embodiments, the body region width 3148 can be in the range from 13.75 mm to 14.25 mm, including the range endpoint values, for example. Other body width values can be used to accommodate various dental restoration shapes and sizes in some embodiments.

In some embodiments, the preform body 3130 can include an insert receiving region 3158 extending at least partially into the body region width 3148 for example from the bottom end face 3162. In some embodiments, the insert receiving region 3158 can have a center axis 3160, an insert receiving region diameter 3144, and an insert receiving region depth 3152. In some embodiments, the insert receiving region diameter 3144 and the insert receiving region depth 3152 can be any suitable values to receiving an insert or an abutment. In some embodiments, the insert receiving region diameter 3144 can be in the range from 2.7 mm to 3.85 mm, including the range endpoints, for example. In some embodiments, the insert receiving region diameter 3144 can be any value suitable to receive and accommodate the diameter of an insert. In some embodiments, the insert receiving region diameter 3144 can also be a value that accounts for any cement or adhesive to affix the insert into the insert receiving region 3158. For example, in some embodiments, the insert receiving region diameter 3144 can be slightly greater than the diameter of the insert diameter by enough to allow a layer of cement or adhesive to at least partially cover the insert in some embodiments. In some embodiments, the insert receiving region depth 3152 can be in the range from 4.45 mm to 4.55 mm, including the range endpoints, for example. In some embodiments, the insert receiving region depth 3152 can be any value suitable to receive and accommodate at least a portion of a length of an insert, for example. In some embodiments, the insert receiving region depth 3152 can also be a value that accounts for any cement or adhesive to affix the insert into the insert receiving region 3158. For example, in some embodiments, the insert receiving region depth 3152 can be slightly greater than the length of the insert portion to be inserted by enough to allow a layer of cement or adhesive to at least partially cover at least a portion of the inserted insert in some embodiments. In some embodiments, the preform 3130 can include a center axis to ledge distance 3135 that can extend from the center axis 3160 to the ledge. In some embodiments, the center axis to ledge distance 3135 can be in the range from 6.675 mm to 6.925 mm, including the range endpoints, for example. In some embodiments, the center axis to ledge distance 3135 can be any value suitable to accommodate a restoration within the preform 3130.

In some embodiments, the preform body 3130 can include a stem 3164 extending from at least a portion of the body width 3148. In some embodiments, the stem 3164 can also extend from other regions or portions of the preform body 3130. In some embodiments, the stem 3164 can include a stem center axis 3138 and have a stem width 3140. In some embodiments, the stem 3164 can be any shape suitable for connecting the stem 3164 (along with the preform body 3130) with an attaching member (not shown). In some embodiments, the stem width 3140 can be any value suitable for connecting the stem 3164 (along with the preform body 3130) with an attaching member (not shown). In some embodiments, the stem width 3140 can be in the range from 4.5 mm to 4.7 mm, including the range endpoints. In some embodiments, any suitable stem width 3140 value can be used. In some embodiments, a stem center to bottom end distance 3141 can be in the range from 5.075 mm to 5.325 mm, including the range endpoints, for all block sizes.

In some embodiments, the preform body 3130 can include an screw receiving region 3154 extending at least partially into the body width 3148 for example from the top end face 3166. In some embodiments, the screw receiving region 3154 can have a center axis 3160, an screw receiving region diameter 3134, and an screw receiving region depth 3168. In some embodiments, the screw receiving region diameter 3134 and the screw receiving region depth 3168 can be any suitable values to receiving an screw and allowing the screw to pass through the screw receiving region 3154. In some embodiments, the screw receiving region diameter 3134 can be in the range from 1.9 mm to 2.7 mm, for example, including the range end points. In some embodiments, the screw receiving region diameter 3134 can be any value suitable to receive and accommodate the diameter of a screw, such as a screw used in an implant system. For example, in some embodiments, the screw receiving region diameter 3134 can be greater than the diameter of the largest diameter of the screw. In some embodiments, the screw receiving region diameter 3134 can be less than the insert receiving region diameter 3144. In some embodiments, the screw receiving region depth 3168 can be determined as the difference between the body region width 3148 and insert receiving region depth 3152, for example. In some embodiments, the screw receiving region depth 3168 can be any value suitable to receive and accommodate an implant screw and any value enough to connect the top region 3168 with the insert receiving region 3158, for example.

In some embodiments, the screw receiving region 3154 connects with the insert receiving region 3158, thereby providing a passage or channel from the top end face 3166 to the bottom end face 3162. In some embodiments, the screw receiving region diameter 3134 is not the same value as the insert receiving region diameter 3144. In some embodiments, the screw receiving region diameter 3134 is less than the insert receiving region diameter 3144.

In some embodiments, the insert receiving region depth 3152 can be determined based on the length of the connecting region of the insert, and the screw receiving region depth 3168 can be determined afterwards as the distance from an inner end 3167 of the insert receiving region 3158 to the top end face 3166.

In some embodiments, an angle 3149 can be any value suitable to accommodate one or more features described in the preform 3130. In some embodiments, the angle 3149 can be in the range from 44 degrees to 46 degrees, for example, including the range endpoints. Other angle values can be used.

As shown in FIG. 3(c), the preform 3200 can include an insert receiving region 3202 with an insert receiving bottom end opening on a bottom end region 3204 of the preform 3200. The insert receiving region 3202 can be suitable to receive at least a portion of an insert shank/connecting region. In some embodiments, where an insert includes one or more anti rotational/locking features such as protrusions, the insert receiving region 3202 can accommodate one or more lobes such as lobe 3206, lobe 3208, and lobe 3210. The size, shape, and number of the one or more lobes can be matched to accommodate and receive one or more corresponding protrusions or other locking/anti rotational features on the insert shank. In some embodiments, this can be done by using CAM to mill the preform with the appropriate lobes based on a virtual insert model. The one or more lobes can be carved out features within the insert receiving region 3202 to allow a protrusion to fit within the lobe.

FIG. 3(d) illustrates an example of a physical preform top region view having a top end face 3101 with a screw receiving region opening 3105. The top end face 3101 can optionally include a label 3110. In some embodiments, a preform body diameter 3102 can be in the range from 16.80 mm to 17.20 mm, including the range endpoints. Other suitable values for the preform body diameter 3102 can be used to accommodate a millable dental restoration design. In some embodiments, a screw receiving region opening distance 3104 can be in the range from 15.90 mm to 16.10 mm, including the range endpoints, for example. Other suitable screw receiving region opening distance 3104 values can be used to accommodate a millable dental restoration. In some embodiments, a ledge length 3103 can be in the range from 8.225 mm to 8.475 mm, including the range endpoints. Other ledge lengths can be used to accommodate a millable dental restoration. In some embodiments, a stem diameter 3110 can be in the range from 4.5 mm to 4.7 mm, including the range endpoints, for example. Other stem diameters can be used to accommodate attachment to a mandrel or other holding device used during milling.

FIG. 3(e) illustrates an example of a physical preform bottom region having a bottom end face 3125 and an insert receiving region 3127. In some embodiments, a preform and stem length 3122 can be in the range from 24.35 mm to 24.65 mm, including the range endpoints, for example. Other preform and stem lengths can be used to accommodate a millable dental restoration and to accommodate attachment to a mandrel or other holding device used during milling. In some embodiments, a stem taper angle 3124 can be in the range from 24 degrees to 30 degrees, including the range endpoints. Other stem taper angles can be used to accommodate attachment to a mandrel or other holding device during milling of the preform. A preform body diameter 3129 can be in the range of 5.075 mm to 5.325 mm, including the range endpoints, for all blocks. Other preform body diameter values can be used.

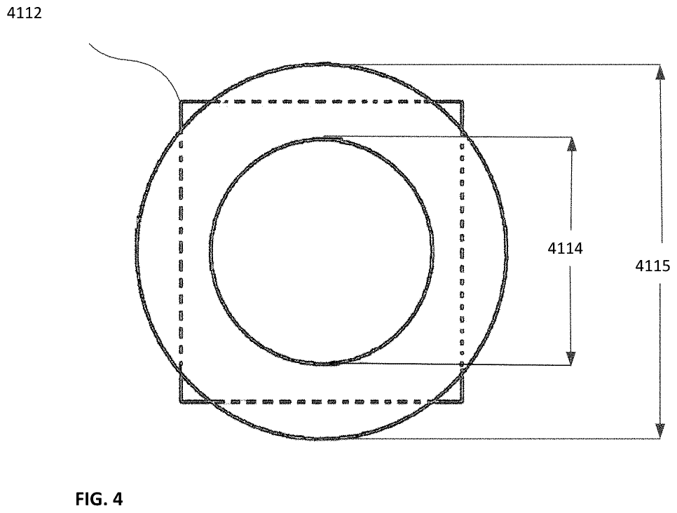

In some embodiments, a preform body having a non-circular cross-section or an irregular shaped cross-section, can have a cross-sectional geometry within the center portion for full rotation 360 degrees of a restoration design around the z-axis. A preform body comprising a top portion, a bottom portion, and a center portion there between can have a cross-sectional geometry (approximately parallel with top and bottom surfaces) with an inscribed circle diameter greater than approximately 12 mm and a circumscribed circle diameter less than approximately 20 mm at a location where the stem projects from the center portion in some embodiments. In contrast, a representation of a preform having a size and shape of known milling preforms (e.g. approximately 15 mm×16 mm) can have a cross-sectional geometry 4112 as illustrated in FIG. 4. In this example, an inscribed circle 4114 of a selected diameter (e.g. 12 mm) can fit within the cross-sectional dimensions of the representative preform. However, the cross-sectional geometry of the representative preform does not fit within a circumscribed circle 4115 of a selected diameter (e.g., about 20 mm) thus, reducing the size of the restoration such as a crown design (or any other restoration design) that may be fully rotated within the known preform design without increasing the size of the preform.

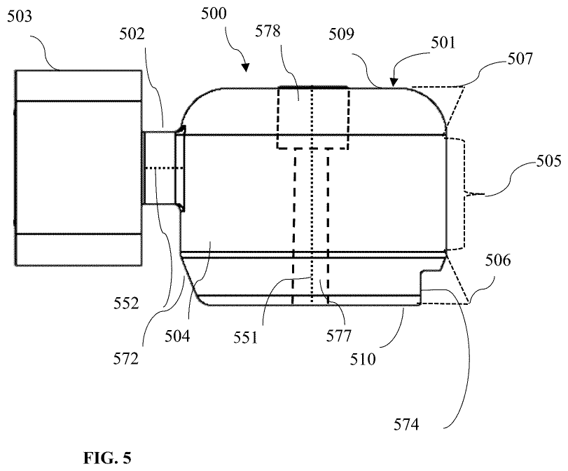

FIG. 5 illustrates an example in some embodiments of a preform 500 whose stem 502 interfaces with an attaching member 503 for direct or indirect attachment to a shaping machine such as a dental milling machine, for example. In some embodiments, the preform 500 can include a preform body 501. In some embodiments, the preform body 501 can include a center portion 505, a top end region 506, and a bottom end region 507. In some embodiments, the center portion 505, the top end region 506, and the bottom end region 507 are a continuous and integral piece of the preform 500. In some embodiments, the top end region 506 can include a chamfered edge 572 on one side of the top end region 506 and a ledge region 574 on another side of the top end region 506. The preform body outer surface 504 diameter can taper from the center portion 505 to the bottom end face 509 and the top end face 510 in some embodiments.

As seen in FIG. 5, in some embodiments, the cylindrical body 501 can have a cylindrical body length 551 oriented substantially orthogonally to a stem 502 axis 552 running along a stem 502 length in some embodiments. In some embodiments, the preform body 501 further can include an insert receiving region 578 within the preform body 501 and extending from the bottom end 507 toward the center portion 505. The insert receiving region 578 can include an insert receiving region opening on the bottom surface of the bottom end 507. In some embodiments, the insert receiving region 578 can extend partly or entirely into the bottom end 507. In some embodiments, as shown in the figure, the insert receiving region 578 can extend through the entire bottom end 507 and partly or entirely into the center portion 505.

In some embodiments, the preform body 501 further can include an screw receiving region 577 within at least a portion of the preform body 501. In some embodiments, the screw receiving region 577 can extend from the top end 506 toward the center portion 505. In some embodiments, at least a portion of the surface of the top end 506 can include a screw receiving region opening to provide access to the screw receiving region 577. In some embodiments, the screw receiving region 577 can extend partly or entirely into the top end 506. In some embodiments, as shown in the figure, the screw receiving region 577 can extend through the entire top end 506 and partly or entirely into the center portion 505.

The insert receiving region 578 can be any size and shape suitable to receive an insert that is part of a dental implant system. For example, in some embodiments, the insert receiving region 578 can be cylindrical or substantially cylindrical. However, other shapes are possible and contemplated to receive any kind of insert of any implant system.

In some embodiments, the diameter of the screw receiving region 577 can be smaller than the diameter of the insert receiving region 578. This can allow, for example, an insert inserted into the insert receiving region to remain in place while allowing a screw to be provided through the screw receiving region 577 to interface with the insert. The screw receiving region 577 and the insert receiving region 578 together can form a channel, passage, or tunnel through the preform body 501. As will be discussed later, a restoration shaped from the preform body 501 can contain at least a portion of the insert receiving region 578 and at least a portion of the screw receiving region 577 after the restoration is formed. The screw receiving region 577 can be any size and shape suitable to receive a screw that is part of a dental implant system. For example, in some embodiments, the screw receiving region 577 can be cylindrical. However, other shapes are possible and contemplated to receive any kind of screw of any implant system.

### Stem

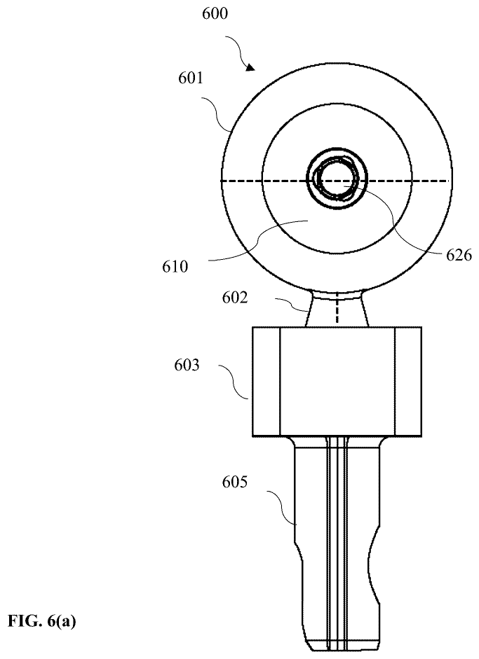

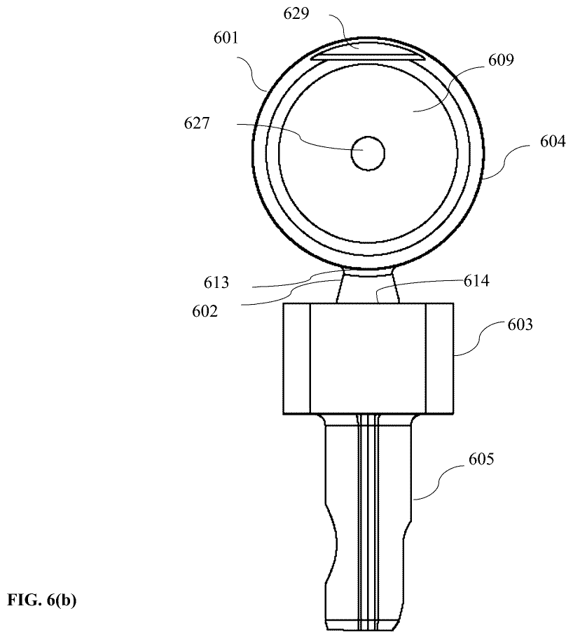

The stem provides support for the preform body during shaping of the final restoration. The stem length may provide a sufficiently large space between the preform body and an attaching member to allow for placement of a grinding tool in a position adjacent the preform body for entry into a tool path without contacting preform material. FIGS. 6(a), 6(b) and 6(c) illustrate an embodiment of a preform 600. The preform can include a ledge 629. The cylindrical preform body 601 can include circular top end face 609 and bottom end face 610, a center portion with a substantially circular cross-section having outer diameter. The top end face 609 can include a screw receiving region opening 627 in some embodiments. The bottom end face 610 can include an insert receiving region 626 in some embodiments. The stem 602 extends away from the curved preform body outer surface 604 of the center portion approximately equidistance between top and bottom ends and to an attaching member 603. The attaching member 603 attaches to a mandrel 605 and provides indirect attachment of the preform to a shaping machine.

In an embodiment exemplified in FIG. 6(a) and FIG. 6(b), the stem 602 bridges the cylindrical body 601 and attaching member 603, and extends generally orthogonally from the cylindrical body outer surface approximately mid-way between the top end and bottom end. In some embodiments, the stem may project from the outer surface of a preform anywhere along the body of the preform.

The axis of the stem length may be substantially orthogonal to the axis of cylindrical body 601 length. The shape of the stem may be a cylinder, cone, prism or the like.

### Sintered Preform Properties

In some embodiments, the preform body is a fully sintered material and the flex strength of the stem 602 at the first end 613 is sufficiently high to support the sintered preform 600 during machining from a sintered state, and sufficiently low for the finished restoration to easily be broken off from the stem, for example, by hand. In some embodiments, the sintered preform is also already shaded.

In some embodiments, prior to shaping the SRR, the length of the preform stem is greater than the stem width at the first stem end 613 proximate the preform body. The stem length may be between about 3 mm and about 12 mm, or between about 3 mm and 10 mm. In some embodiments, the stem length may be greater than about 3 mm, or greater than about 4 mm, or greater than about 5 mm, or greater than about 6 mm, or greater than about 8 mm. In some embodiments, the width (for purposes herein, ‘width’ may also be used to refer to a stem diameter) of the first stem end proximate the cylindrical body is less than the width (diameter) of the second stem end 614 proximate the attaching member 603. The first stem end width 613 may be in the range of 1 mm to 5 mm, or about 1 mm to about 4 mm, or about 1.5 mm to about 3.5 mm, or 1.5 mm to about 3 mm, or less than or equal to about 4 mm, or less than or equal to about 3 mm, or less than or equal to about 2.5 mm, or less than or equal to about 2 mm.

In some embodiments, the ratio of stem length to the first stem end width 613 (the end proximate the cylinder body) is greater than or equal to 1.5:1, or greater than 2:1, or greater than 3:1, or greater than 3.5:1, and less than 6:1, or less than 5:1, or less than 4.5:1, or less than or equal to about 4:1. In some embodiments, the stem has sufficient length to provide access and placement of a machining tool between the attaching member and the cylindrical body, without the tool contacting the preform material, to reduce wear on the machining tool when machining the cylindrical body near the stem. Thus, in this embodiment, the stem length is greater than the diameter of the tool tip, tool shank or both.

The attaching member 603 is joined to the stem at the second end of the stem 614 and secures the machinable preform directly to a shaping machine, or indirectly to an intermediary component (such as a mandrel 605) during the shaping process. The shape and size of the attaching member may be compatible with any machine or intermediary mandrel suitable for shaping the sintered preform to a final dental restoration. The attaching member may secure the sintered preform directly or indirectly to the machine by a mechanical means including, a clamp, a grip, adhesive or other mechanical attachment. For example, the attaching member having a substantially flat bottom surface shaped as a square, rectangular, or circle may be adhesively attached to a mandrel. In another embodiment (not shown), the sintered preform can include an attaching member that is insertably mountable into a mandrel, and is secured by gripping or clamping the attaching member in the mandrel. In one example of this embodiment, the stem is lengthened and the second stem end is shaped to insert into a mandrel. The attaching member may comprise a mechanical attaching means for attachment to a mandrel or directly to a shaping machine, such as a hole for placement of a screw, or a dove tail.

Preform body materials comprising hardness values within a desirable range may include metals, such as cobalt chrome, glass and glass ceramics, such as lithium silicate and lithium disilicate, and ceramics, including sintered ceramics comprising alumina and zirconia. Dental restoration materials, including but not limited to commercially available dental glass, glass ceramic or ceramic, or combinations thereof, may be used for making the machinable preforms described herein. Ceramic materials may comprise zirconia, alumina, yttria, hafnium oxide, tantalum oxide, titanium oxide, niobium oxide and mixtures thereof. Zirconia ceramic materials include materials comprised predominantly of zirconia, including those materials in which zirconia is present in an amount of about 85% to about 100% weight percent of the ceramic material. Zirconia ceramics may comprise zirconia, stabilized zirconia, such as tetragonal, stabilized zirconia, and mixtures thereof. Yttria-stabilized zirconia may comprise about 3 mol % to about 6 mol % yttria-stabilized zirconia, or about 2 mol % to about 7 mol % yttria-stabilized zirconia. Examples of stabilized zirconia suitable for use herein include, but are not limited to, yttria-stabilized zirconia commercially available from (for example, through Tosoh USA, as TZ-3Y grades). Methods form making dental ceramics also suitable for use herein may be found in commonly owned U.S. Pat. No. 8,298,329, which is hereby incorporated herein in its entirety.

### Fabricating Sintered Preforms

Some embodiments can include a method of making one or more screw retained dental restoration (“SRR”) restoration preforms. The method of making one or more Screw retained dental restoration (“SRR”) restoration preforms can include shaping unsintered preform material into one or more unsintered intermediate shaped forms. In some embodiments, shaping can include forming a cylindrical body of unsintered material having a top end, a bottom end, and a center portion and a stem projecting from an outer surface of the cylindrical body. In some embodiments, shaping can include forming an insert receiving region and a screw receiving region in each of the one or more intermediate shaped forms. In some embodiments, shaping unsintered preform material into one or more unsintered intermediate shaped forms is performed prior to sintering. Accordingly, in some embodiments, forming the insert receiving region and forming the screw receiving region can be performed prior to sintering the preform material in some embodiments. In some embodiments, the one or more intermediate shaped forms can be sintered to form one or more sintered preforms.

In some embodiments, the unsintered preform material can be in a bulk form, for example, such as a disk. The bulk material can be zirconia, cubic zirconia, BruxZir NOW material, any type of preform material described herein, or any other type of material suitable for dental restorations such as crowns or other types of dental restorations. In some embodiments, the unsintered preform bulk material can be milled and/or cut into a preform shape as described herein. In some embodiments, the unsintered preform bulk material can be shaped into an unsintered intermediate shaped form using any technique known in the art.

In some embodiments, unsintered materials may be shaped into an intermediate form having substantially the same geometry as the sintered preform, but with enlarged dimensions to accommodate shrinkage upon sintering, where necessary. In some embodiments, the enlarged dimensions can also accommodate for a cement gap in the insert receiving region of the unsintered intermediate shaped form. The intermediate shaped form may be made by injection molding, or milling, or grinding unsintered materials. Suitable unsintered ceramic materials include ceramic powders and ceramic blocks that have not been fully sintered to theoretical maximum density. Ceramic powders may be made into blocks by processes including molding and pressing, including biaxial or iso-static pressing, and may optionally comprise binders and processing aids. Optionally, ceramic powder may be processed into blocks by slip casting processes, including processes described in commonly owned U.S. Patent Publication Nos. 2009/0115084; 2013/0231239; and 2013/0313738, incorporated by reference in their entirety. In some embodiments, the insert receiving region and the screw receiving region can be formed by milling and/or drilling the respective regions into an unsintered preform such as an unsintered intermediate shaped form. The dimensions and shape can be based on virtual models—such as CAD models—of the insert, which through a CAM process can mill the insert receiving region so that it can receive the particular insert. In some embodiments milling can include milling the insert receiving region to have an insert accessible opening on a bottom end of the sintered preform to receive at least a portion of an insert. In some embodiments the insert receiving region can be sized account for a cement gap. In some embodiments the cement gap can include space for cement to affix the insert within the insert receiving region. In some embodiments the cement gap can include 0.02 mm. Other cement gap values can be used if necessary to secure at least a portion of the insert in at least a portion of the insert receiving region. A cement gap may not always be necessary, however, as the insert can stay in place due to mechanical friction between the insert shank and/or protrusion(s) and insert receiving region walls.

Colored materials may be used to make shaded machinable preforms having the color of natural or artificial dentition, requiring no further coloring after formation of the dental restoration. Coloring agents may be incorporated during powder or block formation to more closely match the appearance of natural or commercially available artificial dentition than uncolored or unshaded ceramic materials. For example, U.S. Patent Publication 2013/0231239, describes methods for coloring ceramics by colloidal dispersion and casting the ceramics by slip casting methods, and is incorporated by reference herein, in its entirety. A further example includes US Patent Publication 2014/0109797, which teaches methods for making colored ceramic powder, formed into green state ceramic bodies by isostatic or biaxial press manufacturing processes is also incorporated by reference herein in its entirety. Optionally, coloring agents may be mixed directly with ceramic powders for example, as metallic salts, coloring liquids, or colorized powders, prior to pressing into blocks. Optionally, intermediate preform shapes made from porous materials are shaded, for example, by dipping into coloring liquids, and then sintered.

In some embodiments, the one or more intermediate shaped forms can be sintered to provide one or more sintered preforms. Upon sintering, porosity in pre-sintered ceramic blocks results in shrinkage that may be calculated from the material density with highly predictable shrinkage. Thus, an intermediate shaped form may be larger than the final preform by a scaled factor that anticipates the reduction in size upon sintering to full density. Likewise, intermediate shaped forms made by injection molding unsintered ceramic materials that shrink upon sintering, are designed with an enlargement factor that anticipates size reduction upon sintering. CAD/CAM processes may be used to design the intermediate shaped form, and send corresponding milling instructions for milling with a scaled enlargement factor. Intermediate shaped forms can be milled with commercially available mills and milling/grinding tools, for example, as specified by the manufacturer according to the requirements of the ceramic milling blocks.

In some embodiments, a unitary or monolithic preform comprising the preform body, insert receiving region, screw receiving region, stem can be shaped from a single continuous green-state block or pre-sintered ceramic block, requiring no separate attachment step for attaching the stem and/or attaching member to the preform body. Alternatively, the stem and attaching member may be made as a unitary structure and attached to the preform body as a separate step. In another embodiment, the shaped preform is made by known molding processes, including injection molding, to form a unitary or monolithic preform comprising the preform body, stem and, optionally, the attaching member as a continuous structure. Alternatively, a shaped form may be made by a combination of molding and milling techniques, for example, where an intermediate shaped form is first molded, and then the stem and/or attaching member is milled by standard milling techniques. Alternatively, the stem and attaching member may be separately attached to a preform body, before or after sintering.

The intermediate shaped form may be sintered to a density greater than about 95% of the theoretical maximum density by known sintering protocols. For sintering ceramic preforms, such as zirconia ceramic preforms, to densities greater than about 95%, or greater than about 98% or greater than about 99%, or greater than about 99.5%, of the maximum theoretical density of the ceramic body, material manufacturing protocols suitable for sintering dental restorations may be used. For example, an intermediate shaped form milled from a pre-sintered zirconia block may be sintered at a temperature between about 400° C. and 1700° C., for between about 30 minutes and 48 hours, or according to the sintering protocol provided by the manufacturer of ceramic blocks to form a sintered zirconia preform having a density in the range of about 5.8 g/cm3 and 6.1 g/cm3, such as 6.08 g/cm3, or in a range of about 5.9 g/cm3 and 6.0 g/cm3.

In some embodiments, sintering the unsintered zirconia ceramic intermediate shaped form can achieve a density of about 98% to about 100% percent of the theoretical maximum density of the zirconia ceramic body to form the machinable sintered preform.

In some embodiments of the method, the unsintered zirconia ceramic material is a single pre-sintered ceramic block, and the step of shaping the unsintered ceramic shaped form comprises milling the zirconia pre-sintered ceramic block into a monolithic shaped form comprising a body portion with an insert receiving region and a screw receiving region and a stem as a continuous structure. In another embodiment, the step of shaping the unsintered ceramic form comprises molding the unsintered ceramic material into the monolithic shaped form. In some embodiments, the pre-sintered zirconia ceramic shaped form comprises a cylindrical body and a stem having a first size, and is sintered to form a sintered zirconia preform comprising a cylindrical body and a stem having a reduced second size.

Sintered zirconia preforms that have been fully sintered can be shaped into a finished dental restoration based on a CAD design using a CNC machine and a grinding tool.

The preform body comprises materials that may be shaped as dental restorations and that have sufficient strength properties to be acceptable for use in anterior, posterior or both anterior and posterior dental restoration applications, without additional post-shaping processing steps to alter the material strength properties after shaping, such as by sintering. Sintered preforms may comprise zirconia ceramic materials that have high flexural strength, including strength values greater than about 400 MPa, or greater than about 500 MPa, or greater than about 600 MPa, or greater than about 800 MPA, when tested by a flexural strength test method for zirconia materials as outlined in ISO 6872:2008, as measured and calculated according to the 3 point flexural strength test described for Dentistry-Ceramic Materials.

### Assembling Insert and Sintered Preform

Some embodiments can include a method of making a Screw retained dental restoration (“SRR”) preform. The method of making the SRR preform can include receiving a physical sintered preform having an insert receiving region and affixing a physical insert to the physical sintered preform in the insert receiving region. Affixing the physical insert can include inserting the connecting region of the insert into the insert receiving region of the sintered preform and aligning one or more locking features of the connecting region of the insert with the corresponding elements in the insert receiving region of the sintered preform. This can provide a tight fit for the insert within the insert receiving region of the preform and reduce or prevent rotation and/or movement of the insert. In some embodiments affixing the physical insert can be performed prior to milling a physical restoration from the physical sintered preform. In some embodiments affixing can include cementing the physical insert to the physical sintered preform. In some embodiments cementing can include applying glue/cement to either the connecting region of the insert or to the insert receiving region of the sintered preform. In some embodiments affixing can include placing at least a portion of the physical insert within the insert receiving region. The physical sintered preform can also include a screw receiving region.

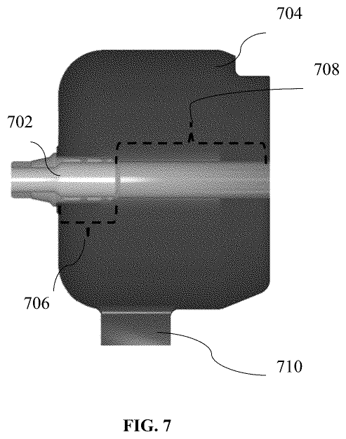

FIG. 7 is an illustration of an example of a physical fully sintered preform with an insert in the insert receiving region in some embodiments. A physical insert 702 is inserted into sintered physical preform 704 in an insert receiving region 706. The sintered physical preform 702 can also include a screw receiving region 708 and a stem 710.

### Generating SRR

Some embodiments can include a computer-implemented method of providing a screw retained dental restoration (“SRR”). The method can include receiving a request to generate a SRR. The request can include a dental implant system type and optionally, other information regarding a patient, facility, and SRR type (crown, full restoration, etc.), and scan data of the patient's dentition. A user placing the request can be any dental professional, including but not limited to a dentist or other user in a dental facility such as a dentist's office.

In some embodiments, the computer-implemented method can retrieve one or more virtual implant parts from a virtual implant library based on the selected dental implant system. The virtual implant parts can be 3D virtual models of one or more physical components of the selected dental implant system. In some embodiments, the virtual implant parts can include a virtual scan-body model, an virtual analog model, a virtual insert model, and a virtual screw model. The virtual implant library can be located locally, in a cloud-based system, and/or in a networked system/environment in some embodiments. In some embodiments, the virtual implant library can include information regarding one or more implant manufacturers, implant system, and implant platform and the associated virtual implant parts.

In some embodiments, the computer-implemented method can include retrieving a virtual preform from a virtual preform library. The virtual preform can correspond to a physical preform, which can be a fully sintered physical preform in some embodiments. The virtual preform library can be located locally, cloud-based, and/or in networked system/environment in some embodiments. In some embodiments, the virtual preform can be a SRR virtual preform. The SRR virtual preform can include a virtual insert receiving region, a virtual screw receiving region, and a virtual stem. The virtual insert receiving region can be dimensioned and shaped to fit/receive a virtual insert model corresponding to the selected dental implant system. The virtual screw receiving region can also correspond to the selected dental implant system. In some embodiments, the SRR virtual preform can be selected by the user. In some embodiments, the SRR virtual preform can be selected automatically upon initiating a request for an SRR based on the dental implant system selected. In some embodiments, the virtual analog, virtual insert, virtual preform, and/or the virtual screw can be displayed on the computer or other device display to the user in the dental facility such as a dental office, for example. In some embodiments, the SRR virtual preform can be displayed with the virtual insert model of the selected dental implant system attached in the virtual insert receiving region of the SRR virtual preform. In some embodiments, the computer-implemented method can request or provide generation of a 3D virtual restoration design model of the SRR. Generation of the virtual restoration design can be performed by an automated process or manually.

The virtual dental restoration design may be created manually by an operator, or automatically proposed, in a dental restoration CAD system. In some embodiments, the digital restoration design (“virtual restoration design” or “virtual restoration”) can be a 3D digital model, and can be stored as a stl/ply/ctx 3D model. In some embodiments, the virtual dental restoration design can be designed in a dental office by a dental professional, by one or more automated processes, and/or by a dental laboratory. Known design systems, such as IOS FASTDESIGN™ System (IOS Technologies, San Diego, Calif.), are suitable for designing dental restorations for use herein, as well as methods disclosed in commonly owned U.S. Pat. Pub. 2015/0056576, U.S. Pat. Nos. 10,248,885, and 10,157,330, the disclosure of each is hereby incorporated herein by reference in the entirety. Automated virtual dental restoration design systems can also be used, including but not limited to those described in U.S. Pat. No. 11,007,040 and in U.S. Pat. No. 11,291,532, the entirety of each of which is hereby incorporated by reference in its entirety.

In some embodiments, a dental implant system can be specified by the dental professional. For example, the dental professional or other user can specify an implant system through a graphical user interface element, for example, such as a drop-down menu or other type of interface. In some embodiments, the implant system type can be provided automatically, and/or read from a user-configurable data file. Any dental implant system type can be used. Some examples of suitable dental implant systems can include Hahn 3.0, Hahn/Nobel Active 3.5/4.3, Hahn/Nobel Active 5.0, Hahn 7.0, Zimmer TSV 3.5, Zimmer TSV 4.5, and Zimmer TSV 5.7, and Inclusive dental implant systems. Other dental implant system types can be selected/used.

Dental implant systems can include several physical components, such as an analog or implant, a scan body, an implant screw, and an insert. The analog or implant is physically installed into the jaw of a patient at a location where the physical screw retained dental restoration will be installed. The insert can have two regions: a connecting region, at least a portion of which is attached within an insert receiving region of the physical restoration, and an interfacing region on the other end of the insert that connects into the analog or implant. An implant screw can be dropped through the physical restoration screw receiving region and affixed to the analog, thereby anchoring the insert and the restoration to the analog or implant at the desired location.

In some embodiments, a physical analog is installed in a patient's jaw during a visit to a dental office. A physical scan body can be temporarily applied/affixed to the physical analog to provide a placeholder for where the physical dental restoration will be installed. The physical scan body can belong to the dental implant system type selected. In some embodiments, an interfacing end of the scan body can be shaped and sized to be placed or removably affixed into the physical analog or implant. In some embodiments, the installed physical scan body can be an abutment. In some embodiments, the physical scan body can be installed into an analog or implant installed in the patient's jaw, and is removable. In some embodiments, the physical scan body can serve as a placeholder for a physical insert of the dental implant system. In some embodiments, the scan body can provide angulation information of the physical insert that will be used for the physical restoration and/or provide insert direction/angle with respect to the surrounding patient dentition.

In some embodiments, anatomical information about the patient's implant site, and optionally, surrounding teeth and the patient's original tooth structure, may be obtained from an intraoral scan or scans of physical impressions taken from the patient. In some embodiments, the scan data with the virtual scan body can be stored in a computer or computer storage media and used to form a digital restoration design.

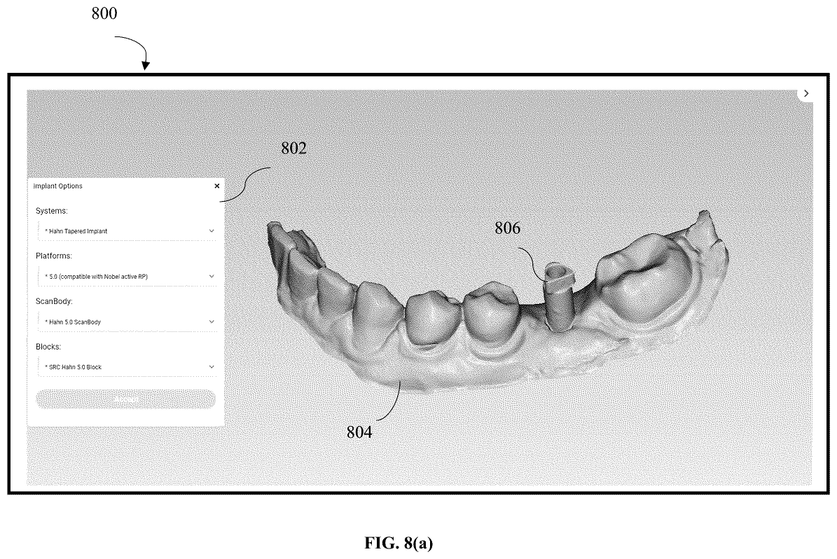

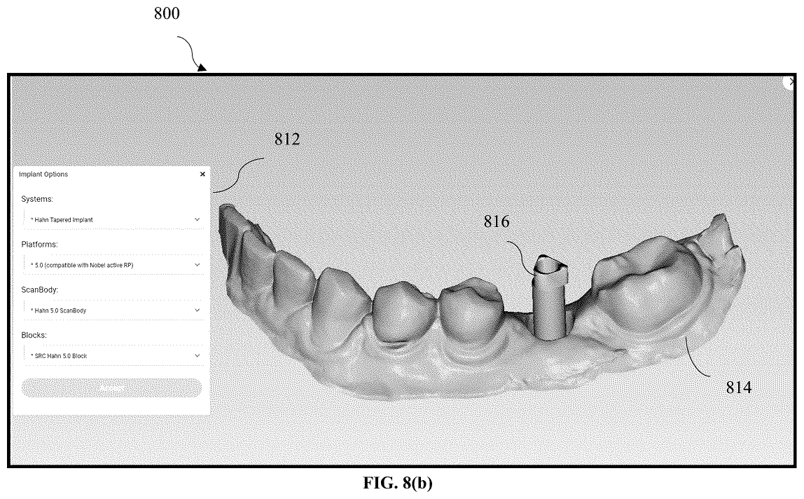

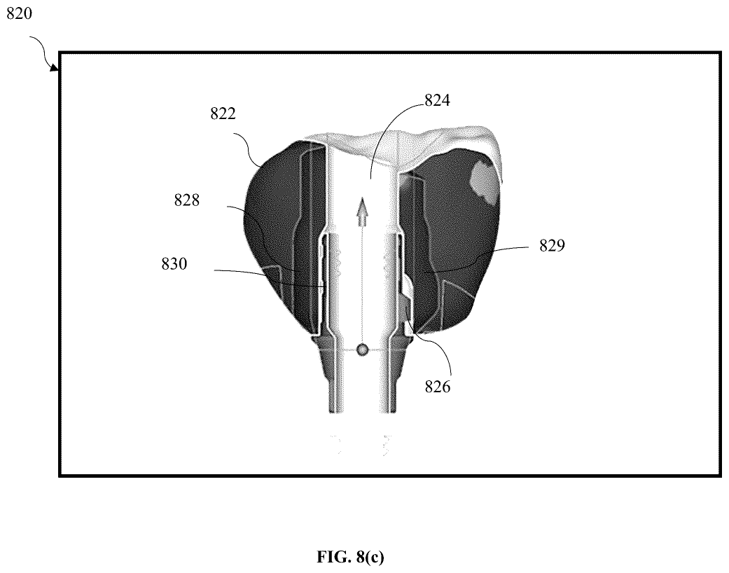

FIG. 8(a) shows an example of a screenshot of a virtual restoration design graphical user interface 800 in some embodiments showing scan data of a patient's dentition and a scan body in some embodiments. A dental implant system selection interface 802 can allow a dentist or other user to select the specific dental implant system that will be used. The scan data can include patient dentition 804 and virtual scan body 806.

In some embodiments, the computer-implemented system can access a stored library of one or more virtual implant system components and select one or more virtual components corresponding to the chosen dental implant system type. The one or more virtual components of the implant system can include a virtual scan body model, a virtual insert model, a virtual screw model, and/or a virtual analog model as well as other virtual components representing/corresponding to the physical components of the dental implant system.

In some embodiments, the computer-implemented method can obtain from the dental implant type library the virtual scan body model corresponding to the selected dental implant system. In some embodiments, the computer implemented method can automatically position, align, and orient the virtual scan body model based on the virtual scan body position, alignment, and orientation in the scan data. In some embodiments, the virtual scan body model can be arranged at the same angle and orientation as the virtual scan body in the scan data. In some embodiments, the virtual scan body can provide the insertion direction for the restoration design (a.k.a. “SRR”).

FIG. 8(b) illustrates an example of a graphical user interface 800 with virtual patient's dentition 814 and a virtual scan body model 816 belonging to the dental implant system selected in the dental implant system selection interface 812. The computer-implemented method can select the virtual scan body model 816 from a library and replace the virtual scan body with the virtual scan body model 816 at the same position and orientation. This can provide information regarding the angle the physical insert will have with respect to the rest of the patient dentition.

In some embodiments, the computer-implemented method can obtain from the stored library the virtual insert model corresponding to the dental implant system type selected. In some embodiments, the computer-implemented method can replace the virtual scan body model in the scan data with the virtual insert model. Accordingly, the virtual insert model can be positioned and oriented in the same way as the virtual scan body model. In some embodiments, the virtual scan body model can also be displayed.

In some embodiments, the computer-implemented system can obtain the virtual insert model and a virtual screw channel (a.k.a. “screw receiving region”) model for the selected dental implant system from a library of models stored for dental implant systems. In some embodiments, the computer-implemented system can, during design of the virtual restoration, display the virtual insert model and the virtual screw channel model in the virtual restoration design. In some embodiments, a connecting region of the virtual insert model can fit into an virtual insert receiving region of the virtual restoration design opposite the occlusal surface. In some embodiments, the virtual insert receiving region can include a virtual insert receiving region opening on a bottom surface (opposite an occlusal surface) of the virtual restoration design. In some embodiments, the virtual screw channel model can correspond to a screw receiving region having an opening on an occlusal surface of the virtual restoration design to receive a virtual screw corresponding to the selected dental implant system. In some embodiments, the virtual insert receiving region and the virtual screw receiving region can be designated as off limit regions that cannot be shaped as part of the dental restoration design. Accordingly, in some embodiments, the computer-implemented method can prohibit or warn removal of material corresponding to the shape and size of the virtual insert receiving region and/or the virtual screw receiving region. In some embodiments, the computer-implemented method can also further expand the prohibited region of both the virtual insert receiving region and the virtual screw receiving region by a user configurable minimum thickness parameter. The minimum thickness parameter can be the required the minimum thickness of the restoration to maintain strength and integrity.

Generating the virtual restoration design can include a proposed margin placement on one or more prepared teeth. In some embodiments, a loop of points can be autogenerated from any user-defined points for the margin, and the generated loop can be adjusted by the user. In some embodiments, the user can initiate design after the margin is complete.

In some embodiments, the computer-implemented method can generate a virtual restoration design having a virtual insert receiving region and a virtual screw receiving region corresponding to the virtual insert model and the virtual screw channel model for the selected dental implant system. In some embodiments, the virtual insert model can be virtually inserted into the virtual restoration design to show the virtual insert model and virtual restoration design together.

FIG. 8(c) depicts a graphical user interface 820 showing a virtual restoration design 822. The virtual restoration design 822 includes prohibited regions 828 and 829 that account for a minimum material thickness required around a virtual insert receiving region 830 and a virtual screw receiving region 824, along with prohibiting the virtual insert receiving region 830 and the virtual screw receiving region 824 themselves in some embodiments. In some embodiments, the computer-implemented method prevents virtual removal from the prohibited regions 828 and 829.

One or more locking/anti rotation features can be accommodated by the shape, size, and orientation of the virtual insert receiving region. For example, for inserts having protrusions/indentations around the insert shank, the virtual insert receiving region can have indentations/protrusions to receive the protrusions along with the insert.

As shown in FIG. 8(c), the virtual restoration design 822 can include a virtual locking/anti-rotation feature 826.

### Virtually Nesting SRR

In some embodiments, a computer-implemented method can nest a computer model of the patient-specific restoration (“virtual restoration”, “virtual restoration design”, or “virtual SRR”) within a computer model of the preform geometry (“virtual preform”). Nesting can determine a desired location and orientation of the virtual restoration design within the virtual preform. Nesting can ensure the virtual restoration design will fit within a virtual preform block. Since a physical restoration will be eventually milled from a physical sintered preform, determining the virtual restoration design will fit within the virtual preform block can help avoid wasted time and materials that can result from a physical restoration design not fitting properly within the physical preform. Nesting can also provide, for example, optimal placement of a virtual sprue that connects with the virtual restoration in some embodiments. The virtual sprue can emanate from or is shaped from the virtual stem of the virtual preform and provides a dentist or other user a handle or holding mechanism when installing the physical restoration. In some embodiments, the virtual sprue can connect at an angle where the virtual sprue connects to the most prominent Z position of the virtual restoration, such as a crown or other restoration. Allowing the virtual sprue to connect at an angle with the virtual restoration along the Z axis can minimize/avoid an undercut without having to move the virtual restoration along the Z axis.

In some embodiments, the virtual preform can include a virtual preform screw receiving region. In some embodiments, the virtual preform can include a virtual preform screw receiving region opening on a top end of the virtual preform (the region furthest from the virtual insert receiving region). In some embodiments, the virtual preform can also include a virtual preform insert receiving region, which can include one or more structural features to accept locking/anti-rotation features that may be present on the insert. For example, in some embodiments, the virtual preform insert receiving region can include one or more lobes corresponding to one or more protrusions on a shank of the insert to be used. In some embodiments, the virtual preform can also include a virtual insert model inserted into the virtual preform insert receiving region. The virtual insert model can correspond to the physical insert that has been inserted into the corresponding physical preform as described herein. Accordingly, in some embodiments, the virtual preform with the inserted virtual insert model can correspond to the physical preform with the inserted physical insert that will be used by the dentist to mill a physical restoration. In some embodiments the virtual preform corresponds to a physical preform, the virtual insert corresponds to a physical insert, the virtual screw accessible opening corresponds to a screw accessible opening, and the virtual screw receiving region corresponds to a physical screw receiving region of the physical preform.

In some embodiments, the virtual restoration design can include a virtual screw access opening on a surface (such as an occlusal surface) of the virtual restoration. In some embodiments, the virtual restoration can also include a virtual screw receiving region within the virtual restoration. The virtual screw access opening and any virtual restoration screw receiving region can be designed to be part of the virtual restoration as discussed previously based on the virtual insert model and the virtual screw channel model for the selected dental implant system. In some embodiments, the virtual restoration design can also include a virtual insert receiving region as described previously.

In some embodiments, the computer model of a patient's dental restoration design may be selectively nested in one or more optional positions within a computer model of the preform (“virtual preform”).

In some embodiments, nesting of the virtual restoration design is performed in an insert model space rather than a machining space. In some embodiments insert model space can include displaying one or more virtual dental implant system components such as a virtual insert model and/or other components, and also display a virtual preform, a virtual restoration, and a virtual sprue connected to the virtual restoration. In some embodiments the virtual insert model can be virtually affixed to the virtual restoration. In some embodiments a toolpath can be generated in the virtual model (CAD) and provided to a milling side (CAM) in machine coordinates to generate/grind/mill a physical sintered SRR from a physical sintered preform. In some embodiments insert model space can be displayed in a chairside computer application to allow a dental professional to visualize nesting the virtual restoration within the virtual preform. In some embodiments the insert model space displayed can include a virtual sprue connected to the virtual restoration and/or the virtual insert model.

In some embodiments, nesting the virtual restoration design can include virtually aligning the virtual restoration model within the virtual preform. In some embodiments, the virtual restoration design is aligned based on a dental implant system. In some embodiments aligning the virtual restoration within the virtual preform places a sprue relative to an orientation such as a rotational position of the virtual insert for the selected dental implant system. In some embodiments, nesting the virtual restoration design can include virtually aligning in three dimensions the virtual restoration within the virtual preform.

In some embodiments, the virtual restoration design model can include a virtual insert receiving region. In some embodiments, alignment can include aligning a central axis of the virtual restoration model insert receiving region with a virtual preform insert receiving region axis. In some embodiments, alignment can include aligning a central axis of the virtual restoration model insert receiving region with a Z-axis of global space of the insert model so that the central axis is over the zero point of the global space.

In some embodiments, the virtual restoration model can include a virtual restoration model screw receiving region. In some embodiments, alignment can include aligning a central axis of the virtual restoration model screw receiving region with a virtual preform screw receiving region axis. In some embodiments, alignment can include aligning a central axis of the virtual restoration model screw receiving region with a Z-axis of global space of the insert model so that the central axis is over the zero point of the global space.

In some embodiments, the virtual restoration model can include a virtual restoration model insert receiving region opening. In some embodiments, alignment can include aligning a central axis of the virtual restoration model insert receiving region opening with a virtual preform insert receiving region axis. In some embodiments, alignment can include aligning a central axis of the virtual restoration model insert receiving region opening with a Z-axis of global space of the insert model so that the central axis is over the zero point of the global space.

In some embodiments, aligning can include determining one or more virtual restoration bottom most (non occlusal side) surface regions and mapping the one or more virtual restoration bottom most surface regions with one or more virtual preform bottom surface regions. In some embodiments, aligning can include aligning one or more virtual restoration design locking/anti-rotational features with one or more corresponding virtual preform locking/anti-rotational features. For example, in some embodiments, aligning can include rotating the virtual design until one or more virtual restoration lobes line up with one or more virtual preform lobes.

Other techniques for aligning the virtual restoration design model within the virtual preform can be used.

In some embodiments, the virtual implant top point can be set to Z=0. A minimum restoration height can also be placed at the insert height in some embodiments. In some embodiments, at least a portion of the virtual insert such as an interfacing region can be affixed in a virtual receiving region of the virtual restoration.

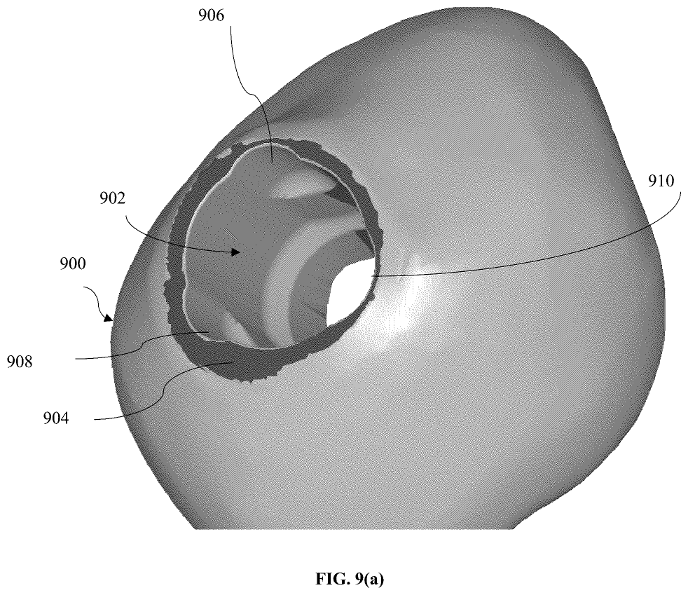

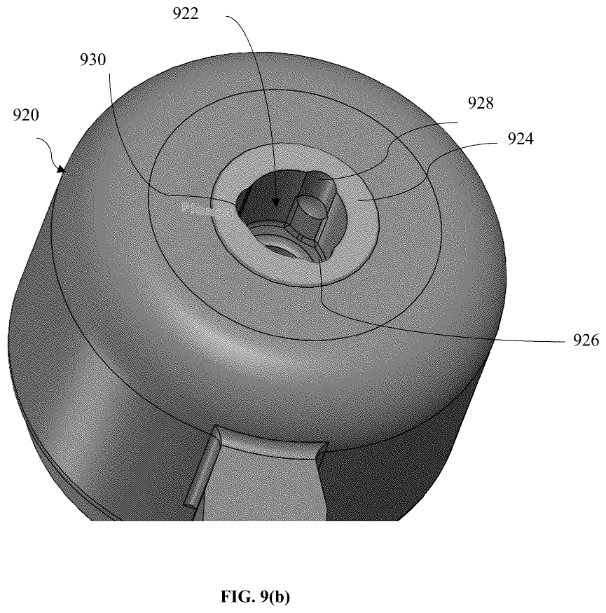

FIG. 9(a) illustrates an example of a portion of a virtual restoration design 900 that includes a virtual insert receiving region 902. In some embodiments, the virtual insert region 902 can include a virtual restoration bottom region such as virtual restoration bottom region 904 and, optionally, one or more virtual restoration lobes such as virtual restoration lobe 906, virtual restoration lobe 908, and virtual restoration lobe 910. More or fewer lobes are possible.

FIG. 9(b) illustrates an example of a portion of a virtual preform 920 that includes a virtual preform insert receiving region 922. In some embodiments, the virtual preform 920 can include a virtual preform bottom region such as virtual preform bottom region 924 and, optionally, one or more virtual preform lobes such as virtual preform lobe 926, virtual preform lobe 928, and virtual preform lobe 930. More or fewer lobes are possible.

In some embodiments, the computer-implemented method can align the bottom of the virtual restoration design 900 with the bottom of the virtual preform 920. In some embodiments, the computer-implemented method can align the virtual restoration bottom region 904 with the preform bottom region 924.

In some embodiments, the computer-implemented method can align one or more lobes of the virtual restoration design 900 with one or more lobes of the virtual preform 920. For example, the computer-implemented method can align virtual restoration lobes 906, 908, and 910 with virtual preform lobes 926, 928, and 930.

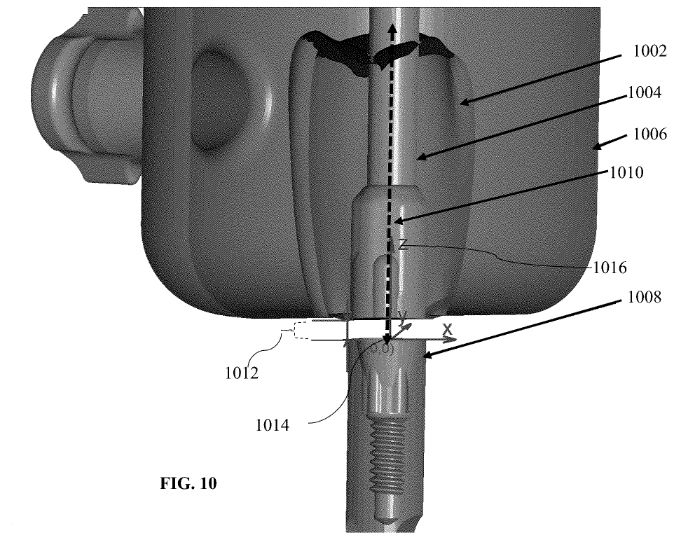

FIG. 10 illustrates an example of a virtual restoration design 1002 aligned within a virtual preform 1006. As shown in the figure, a virtual implant 1008 top point 1014 can be set to Z=0. The virtual restoration design 1002 can have a central axis 1010 aligned with the screw receiving region 1004 of the virtual preform 1006. The central axis 1010 can correspond to a scanned abutment, a virtual restoration design screw receiving region opening, a virtual restoration design screw receiving region, and/or a virtual restoration design insert receiving region. The central axis 1010 is along the Z-axis 1016 of global space in the insert model, with x,y,z coordinates (0,0,0) at top point 1014 through which the central axis 1010 passes. A configurable insert height 1012 can be defined between the virtual implant top point 1014 and the virtual preform 1006.

In some embodiments, the computer-implemented method can determine a virtual sprue position on the virtual restoration design model as part of nesting, or in another step. In some embodiments, the virtual sprue is an extension of the virtual stem into the virtual preform. In some embodiments, the virtual sprue can have the same diameter/length and shape as the virtual stem portion connected to the virtual preform. In some embodiments, the virtual sprue can be reduced or tapered in size. In some embodiments, the virtual sprue can be substantially cylindrical in shape. Other shapes can be used. In some embodiments, determining the virtual sprue position on the virtual restoration design model can include rotating the virtual restoration design model to one or more rotational positions around the central axis/virtual screw receiving region/opening. In some embodiments, the number of rotational positions is a user-configurable value. In some embodiments, the number of rotational positions and the location of each rotational position is based on the selected dental implant system. In some embodiments, the one or more rotational positions correspond to a shape of the interfacing region of the virtual insert and the virtual analog or implant. As discussed herein, a cross section of a interfacing region of an insert can be in the shape of a polygon inserting region that can fit into a similarly shaped cross section of a receiving region of the analog or implant. The number of rotational positions can correspond to the number of sides of the polygon in some embodiments. For example, if the interfacing region of the insert is in the shape of a hexagon, then six nesting positions can be available. If the interfacing region of the insert is in the shape of an octagon, then eight nesting positions can be available. If the interfacing region of the insert is a pentagon, then five nesting positions can be available.

In some embodiments, the virtual sprue location on the virtual restoration design can be selected such that the virtual sprue extends as straight as possible from the virtual stem to a virtual restoration design surface. In some embodiments, the virtual sprue location on the virtual restoration design can be selected such that the virtual sprue is not on a virtual restoration design contact region. In some embodiments, the virtual restoration design contact region can be an occlusal region of the virtual restoration design. In some embodiments, the contact region can be specified by a user, or determined automatically by a CAD/CAM or other computer-implemented method/system. Accordingly, in some embodiments, the virtual sprue avoids an occlusal region of the virtual restoration design. In some embodiments the virtual sprue location chosen can include a location on the virtual restoration model closest to a virtual stem/separator. In some embodiments the virtual sprue can be inclined or angled with respect to a virtual separator region for a virtual restoration design having a height along the virtual screw receiving region axis above or below the virtual separator region. In some embodiments, the virtual sprue location can be selected by the user after being presented with the available virtual sprue locations corresponding the specific dental implant system selected. In some embodiments, the computer-implemented method can automatically determine the optimal location on the virtual restoration design for the virtual sprue. In some embodiments, the computer-implemented method can automatically determine and propose the virtual sprue location, but allow it to be changed manually through an interface. In the case of a manual selection, the virtual restoration design can be rotated to accommodated the virtual sprue connecting to the selected location, and adjust the angle of the virtual sprue with respect to the virtual stem.

In some embodiments, the virtual sprue can be shown extending from the virtual stem and connected to the virtual restoration design at the selected position along with the virtual preform, the virtual stem, and the virtual insert model.

In some embodiments, virtually nesting can also include determining a default insertion direction along the virtual restoration screw receiving region axis, which can be along the Z-axis as discussed herein.

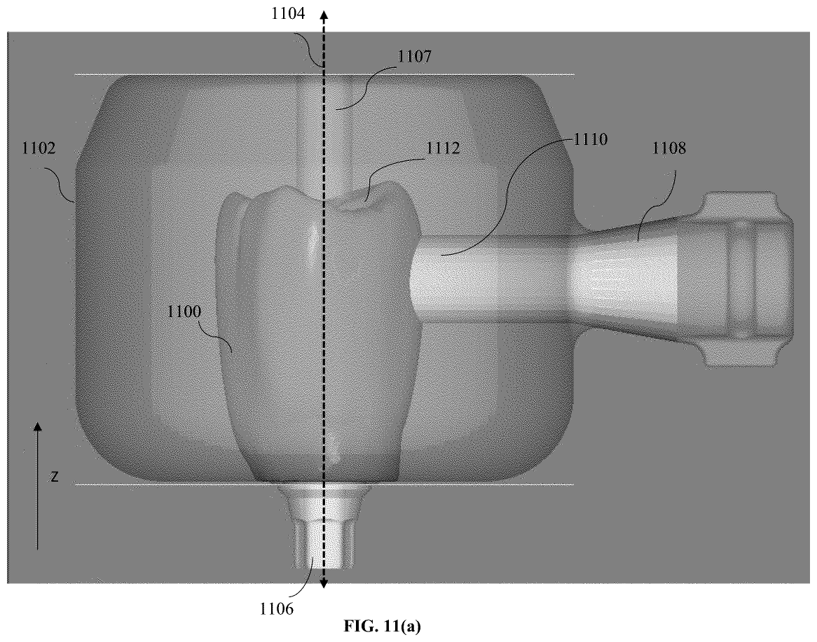

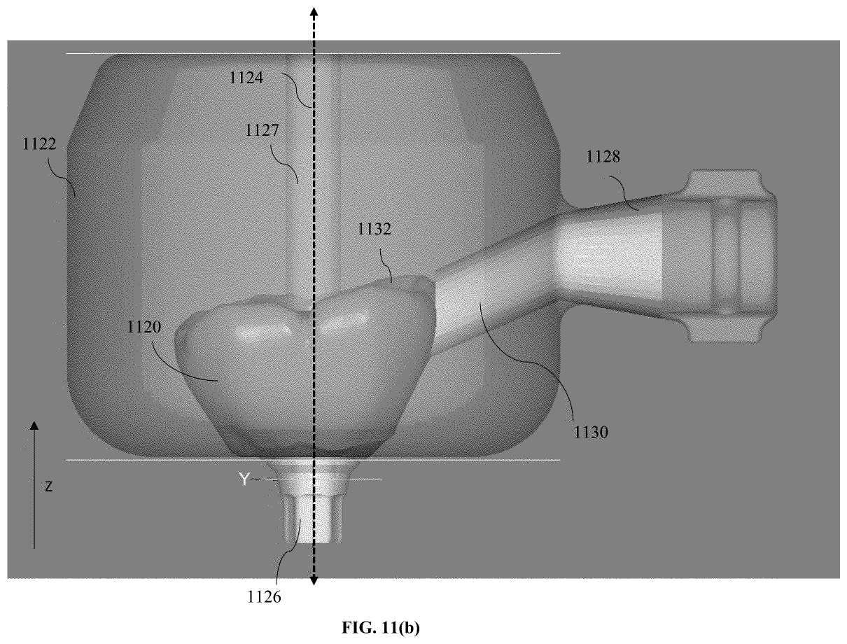

In FIG. 11(a) and FIG. 11(b), a model of the dental restoration design may be nested within the geometry of the virtual preform body.

As illustrated in FIG. 11(a), a nesting method can include arranging a virtual restoration design 1100 in a virtual preform body 1102 at a rotational positional around an axis 1104, which can be in the Z-axis direction of a grinding tool when placed in a milling machine. In some embodiments, a virtual insert model 1106 is affixed to the virtual restoration design 1100. The virtual preform screw receiving region 1107 can also be displayed and can be based on the selected dental implant system in some embodiments for example. The virtual insert model 1106 can be specific to the selected dental implant system, and can determine the number and rotational positions. In some embodiments, the virtual restoration design 1100 can be rotated around the axis 1104 to one or more rotational positions. In some embodiments, the one or more rotational positions can correspond to the number of sides of a connecting region of the virtual insert 1106. In some embodiments, the virtual sprue 1110 extending from the virtual stem 1108 can be designed to avoid contact areas such as virtual contact area 1112. In the figure shown, the virtual sprue 1110 extends substantially straight from the virtual stem 1108, avoids contact area 1112.

In some embodiments, as exemplified, a nesting option may be selected based on the location of the virtual stem 1108 relative to the virtual restoration design 1100. The method further comprises designing a virtual sprue 1110 extending from the virtual stem 1108 within the body of the virtual preform body 1102 that will be milled during the restoration milling process.

As illustrated in FIG. 11(b), a nesting method can include arranging a virtual restoration design 1120 in a virtual preform body 1122 at a rotational positional around axis 1124, which can be in the Z-axis direction of a grinding tool when placed in a milling machine. In some embodiments, a virtual insert model 1126 is affixed to the virtual restoration design 1120. The virtual preform screw receiving region 1127 can also be displayed and can be based on the selected dental implant system in some embodiments for example. The virtual insert model 1126 can be specific to the selected dental implant system, and can determine the number of rotational positions. In some embodiments, the virtual restoration design 1120 can be rotated around the axis 1124 to one or more rotational positions. In some embodiments, the one or more rotational positions can correspond to the number of sides of a connecting region of the virtual insert model 1126. In some embodiments, the virtual sprue 1130 extending from the virtual stem 1128 can be designed to avoid contact areas such as virtual contact area 1132. In the figure shown, the virtual sprue 1130 is angled from the virtual stem 1128 due to the height of the virtual restoration design 1120, and avoids contact area 1132. In this figure, other rotational positions may not be selected due to the lower height of the virtual restoration design 1120, which can require a greater angle for the virtual sprue 1130 to contact the side of the virtual restoration design 1120, and/or require the virtual sprue 1130 to be located further from the virtual stem 1128, and/or connect to the contact area.

In some embodiments, the computer-implemented method can determine one or more virtual restoration design regions that are outside of the virtual preform at one or more rotational positions. In some embodiments, these outside regions are indicated to the user. In some embodiments, the user or an automated process can address the one or more outside regions by altering the virtual restoration design, or by selecting a different rotational position of the virtual restoration design within the virtual preform that prevents any outside regions.

In some embodiments, the computer-implemented method can use nesting threshold parameters to provide for a minimum distance between the outer surface of the preform body and the outer surface of the virtual restoration design, or between the surface of the virtual stem and the gingival margin. For example, in some embodiments the stem outer surface and the gingival margin may be at least 0.5 mm, or at least 1 mm, or between 0.5 mm and 3 mm. Optionally, a distance between the virtual restoration design outer surface and the edge of the virtual preform body may be at least 0.2 mm, or at least 0.5 mm, or at least 1 mm. Further, a minimum distance between the virtual restoration design surface and the virtual stem may be established, for example, to be about 0.5 mm to 1.5 mm. Positional data of the nested restoration design may be provided to the CAM system to calculate tool paths to shape the final restoration from the preform.

In some embodiments, the virtual nesting result can be adjusted by the user. In some embodiments, the computer-implemented method can utilize nesting result without modification.

### Milling Paths

Some embodiments can include a computer-implemented method of providing Screw retained dental restorations (“SRR”) such as screw retained crowns in some embodiments, or any other restoration. The computer-implemented method can include receiving a virtual restoration model and generating one or more virtual toolpaths corresponding to a virtual restoration shape of the virtual restoration design. The one or more virtual toolpaths can be spiral toolpaths. The one or more virtual toolpaths can be helical spiral toolpaths. In some embodiments the one more virtual toolpaths correspond to at least a portion of a virtual sprue connected to the virtual restoration. The one or more virtual toolpaths correspond to a virtual restoration shape in three dimensions. The virtual restoration design can include a virtual screw receiving region and a virtual insert receiving region. In some embodiments, generating the one or more virtual spiral toolpaths can be performed after the virtual design is nested in the virtual preform and after determining the location of the virtual sprue. In some embodiments the one or more virtual toolpaths correspond to one or more milling paths used by a milling machine to shape/grind/mill a physical restoration corresponding to the virtual restoration from a sintered physical preform. In some embodiments, milling can include grinding. In some embodiments the one or more virtual toolpaths can also correspond to a virtual sprue. In some embodiments the virtual sprue can include a bottom portion of the virtual sprue and a top portion of the virtual sprue. In some embodiments the bottom portion of the virtual sprue can include a virtual sprue region closest to the base (a.k.a. bottom or non occlusal side) region of the virtual restoration, and the top portion of the virtual sprue can include the virtual sprue region closest to the occlusal surface of the virtual restoration. In some embodiments the one or more virtual toolpaths each comprise a virtual spiral line beginning from an outside region of the virtual preform and going toward the inside of the virtual preform. Some embodiments can include a separate virtual sprue reduction toolpath to reduce the diameter of the virtual sprue near the virtual restoration.

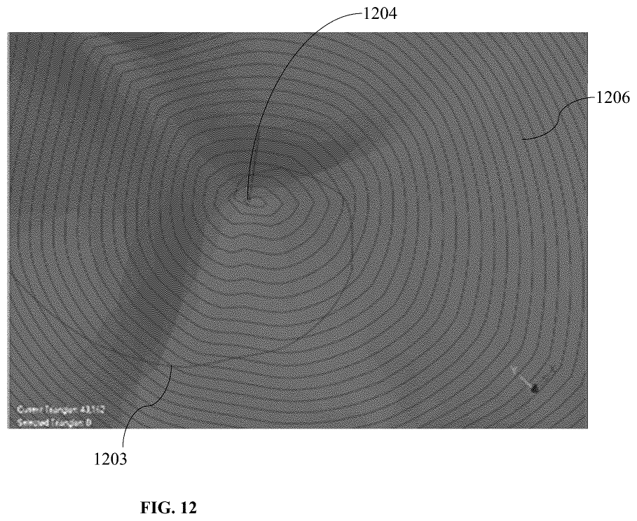

FIG. 12 illustrates an example of a spiral helical virtual toolpath in some embodiments. Spiral virtual toolpath 1202 begins from an outside region and forms a spiral region 1203 transitioning toward a center 1204 of the preform after completing a loop such as loop 1206. The spiral region 1203 can be formed as the spiral virtual toolpath transitions from one loop to the next loop.

In some embodiments, virtual restoration design can be divided into two regions: a lower virtual restoration design region and an upper virtual restoration design region. In some embodiments, the lower virtual restoration design region and the upper virtual restoration design region can be separated by a virtual separator. The virtual separator can be auto-generated. In some embodiments, the virtual separator can be autogenerated by determining (tracing) an outer most surface of the virtual restoration design when looking directly along the insertion axis of the virtual insert model. The lower virtual restoration design region can correspond to the virtual restoration design region having the virtual insert model and can extend up to the virtual separator. The upper virtual restoration design region can include at least a portion of a region on the opposite side of the virtual separator and away from the virtual insert model. The lower virtual restoration design region can also be referred to as the base or insert virtual restoration design region since it relates to a virtual toolpath associated with the insert and surrounding region up to the virtual separator. The upper virtual restoration design region can also be referred to as an occlusal virtual restoration design region since it relates to a virtual toolpath associated with the occlusal surface and surrounding region up to the virtual separator.

In some embodiments, a virtual sprue separator can divide the virtual sprue into an upper virtual sprue region and a lower virtual sprue region. In some embodiments, the virtual sprue separator can be determined for the virtual sprue region by also determining (tracing) an outer most surface of the virtual sprue when looking directly along the insertion axis of the virtual insert model. The lower virtual sprue can also be referred to as the base or insert virtual sprue region since it relates to a virtual toolpath for the virtual sprue region associated with the insert and surrounding region up to the virtual sprue separator. The upper virtual sprue region can also be referred to as an occlusal virtual sprue design region since it relates to a virtual toolpath for the virtual sprue associated with the occlusal surface and surrounding region up to the virtual sprue separator.

In some embodiments, the computer-implemented method can generate a lower region virtual toolpath corresponding to the lower virtual restoration design region and the lower virtual sprue region. In some embodiments, the lower region virtual toolpath can be a single continuous toolpath following the 3 dimensional shape of the lower virtual restoration design region and the lower virtual sprue region. In some embodiments, the lower region virtual toolpath can be a continuous spiraling toolpath.

In some embodiments, the computer-implemented method can generate a upper region virtual toolpath corresponding to the upper virtual restoration design region and the upper virtual sprue region. In some embodiments, the upper region virtual toolpath can be a single continuous toolpath following the 3 dimensional shape of the upper virtual restoration design region and the upper virtual sprue region. In some embodiments, the upper region virtual toolpath can be a continuous spiraling toolpath.

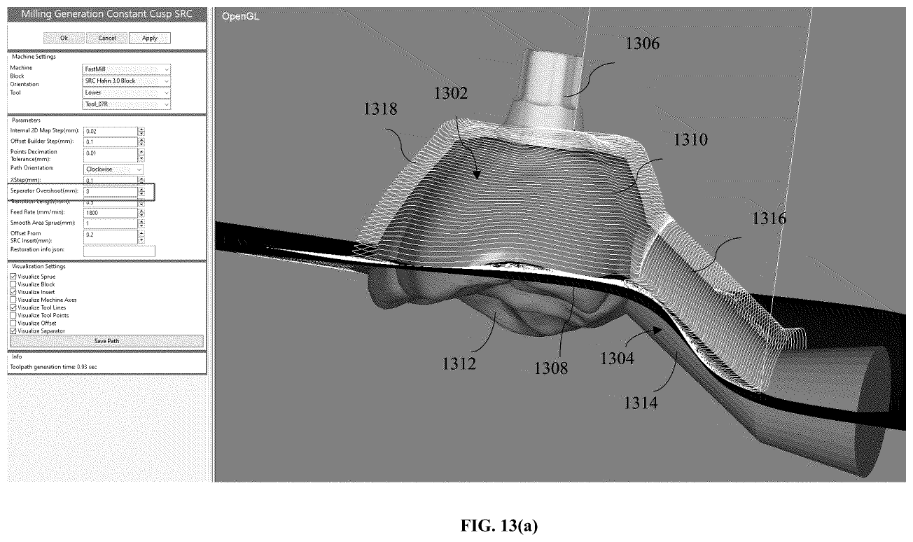

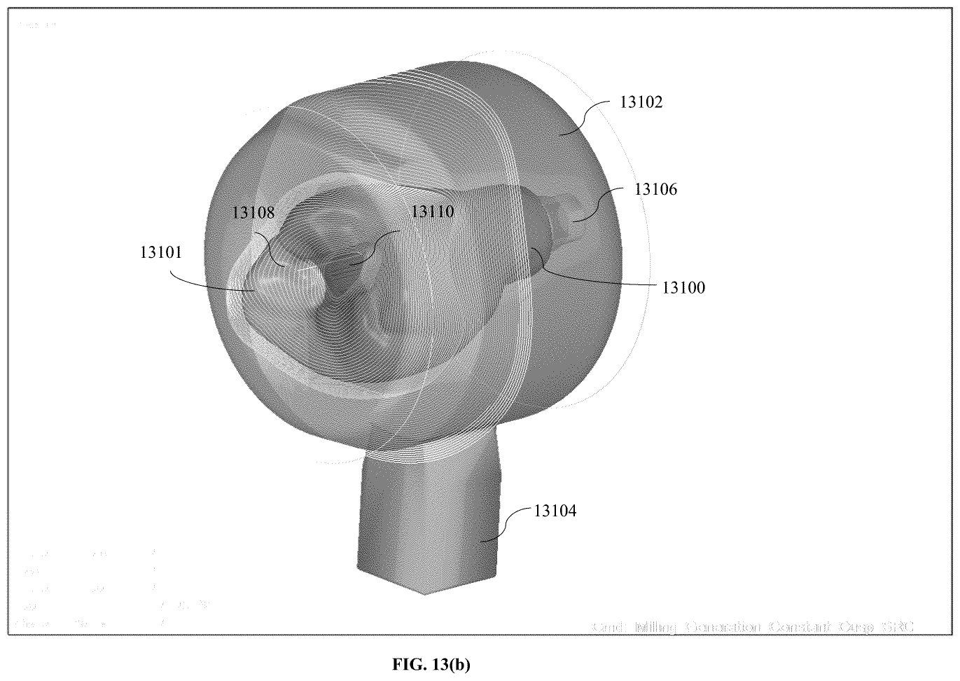

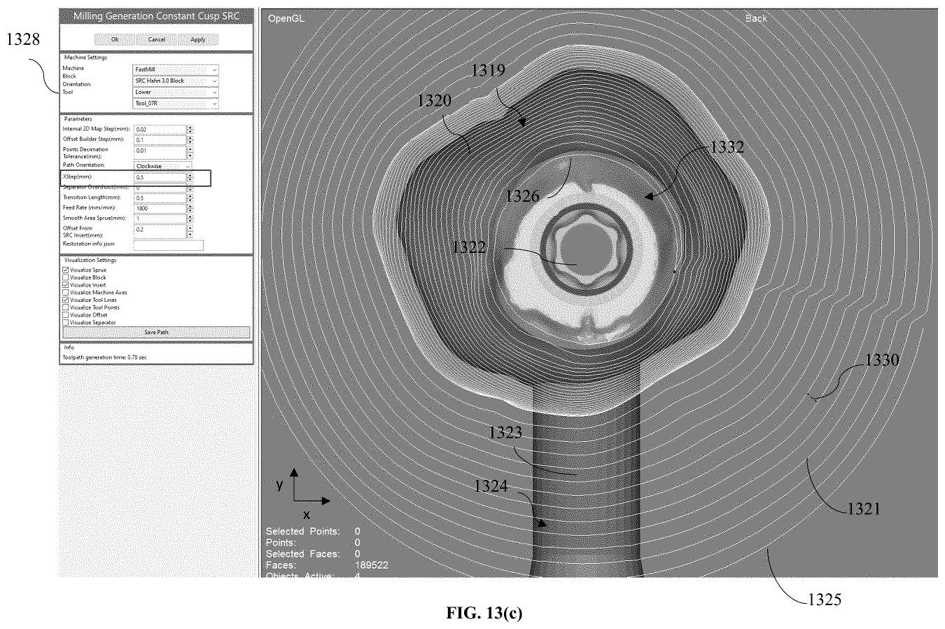

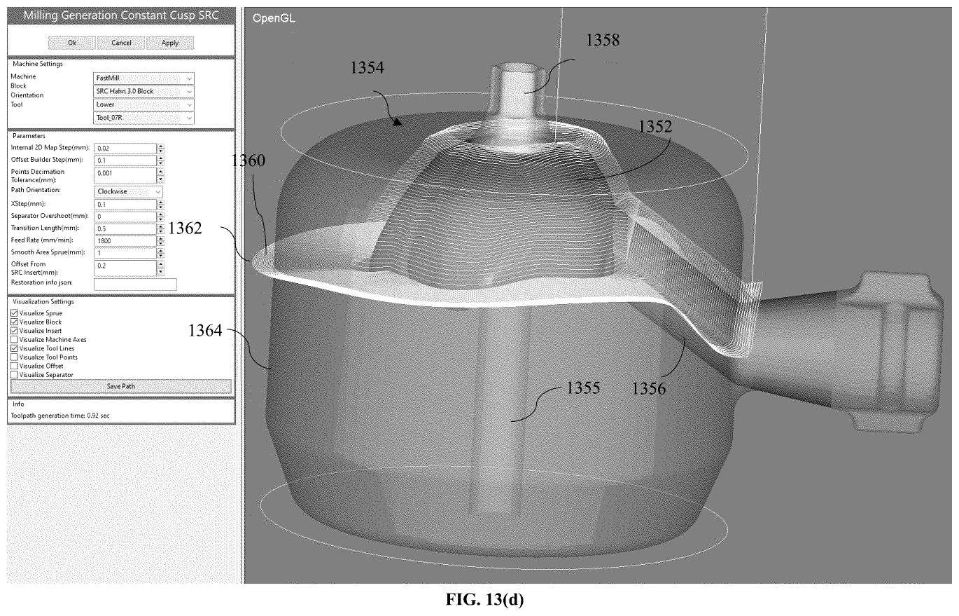

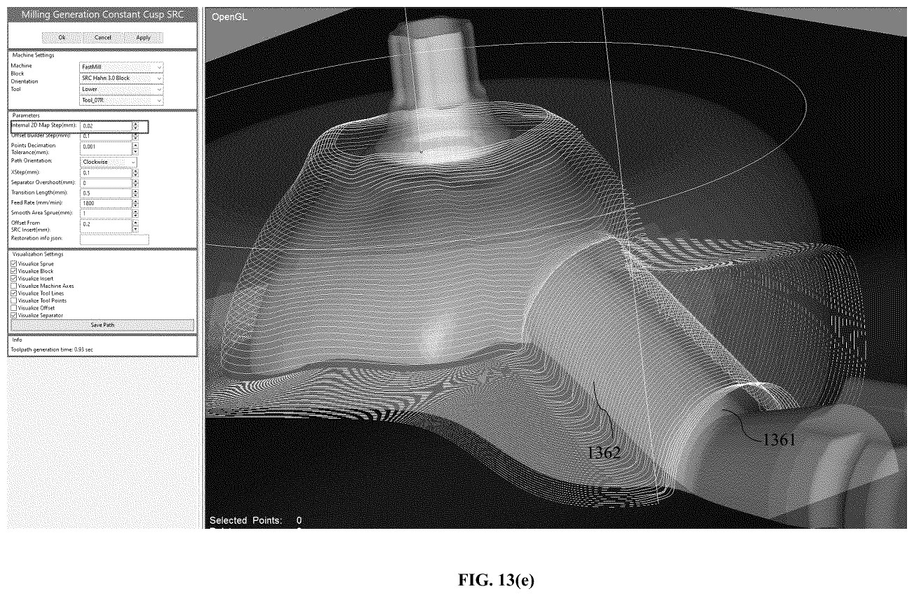

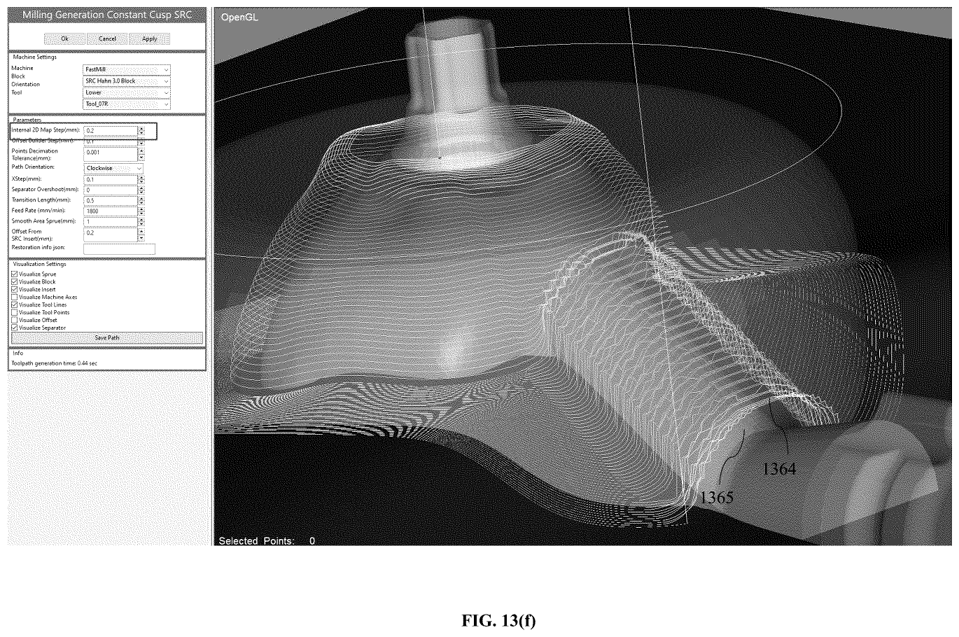

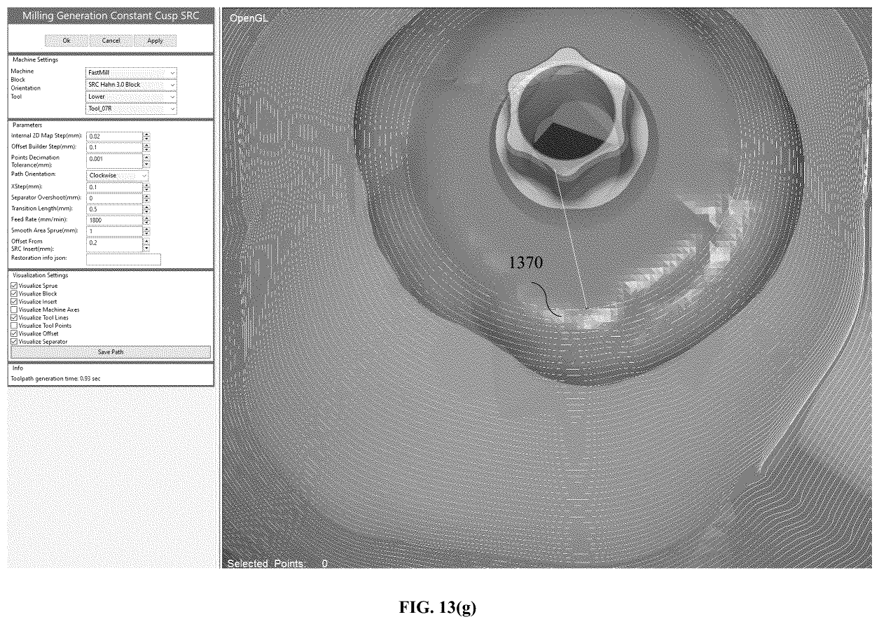

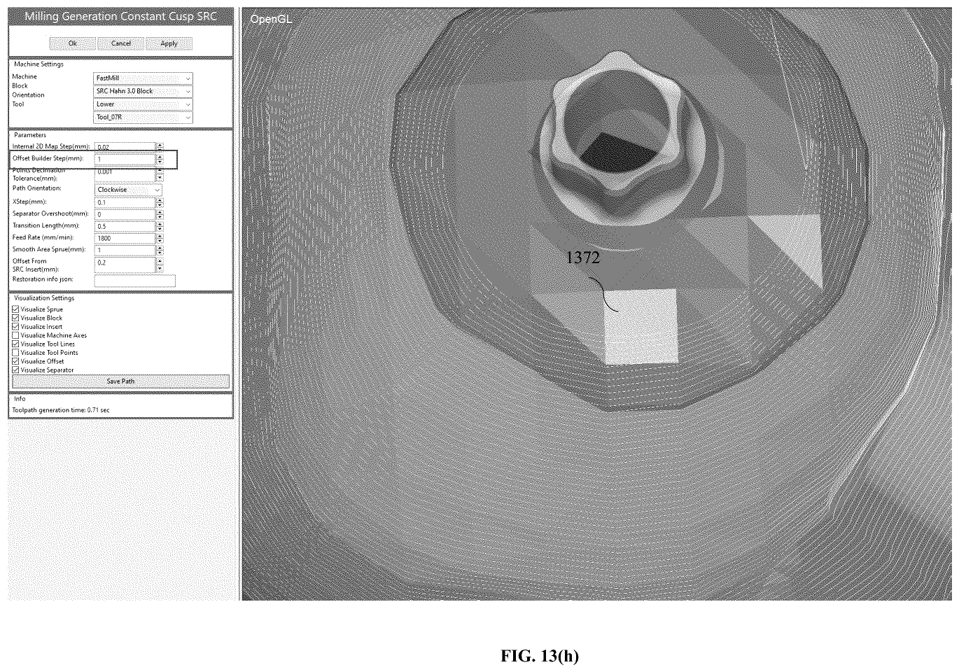

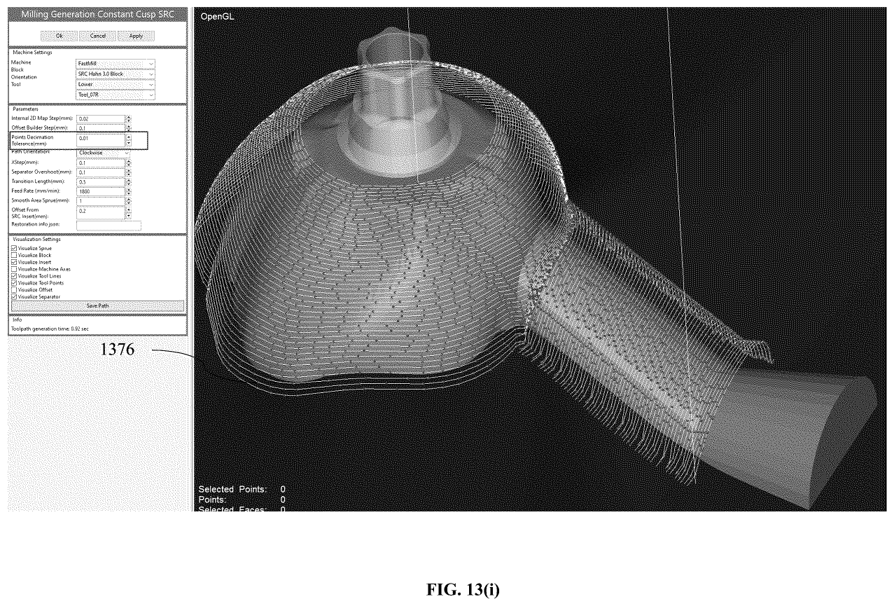

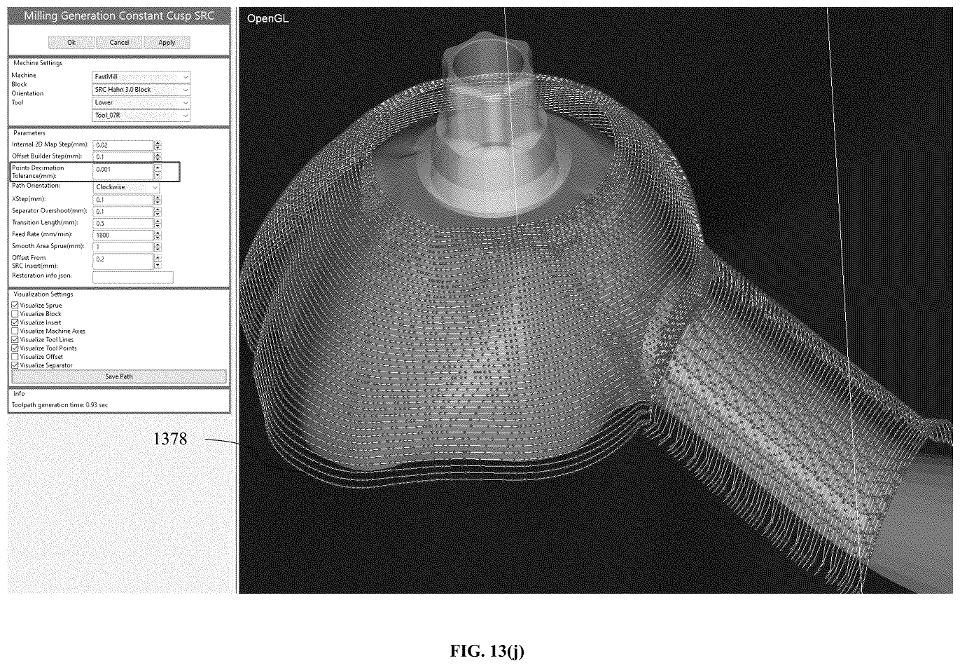

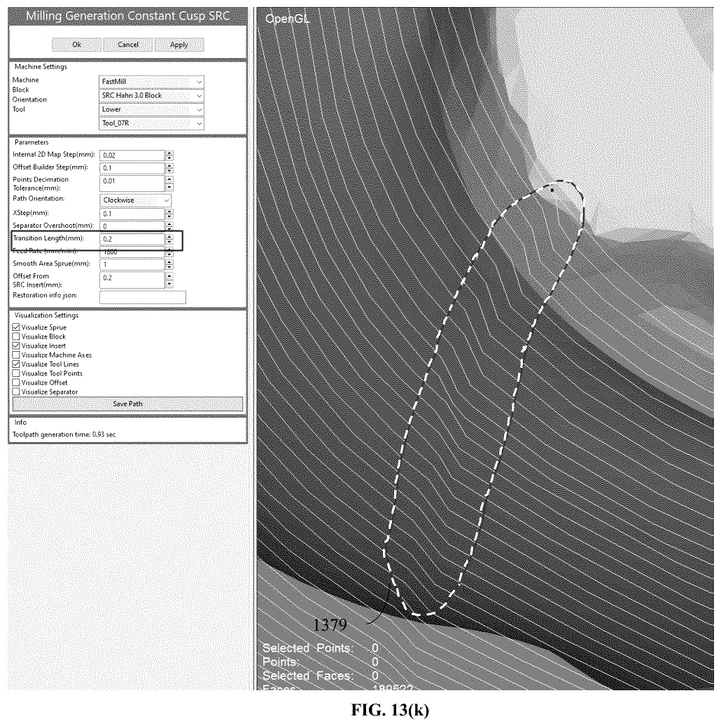

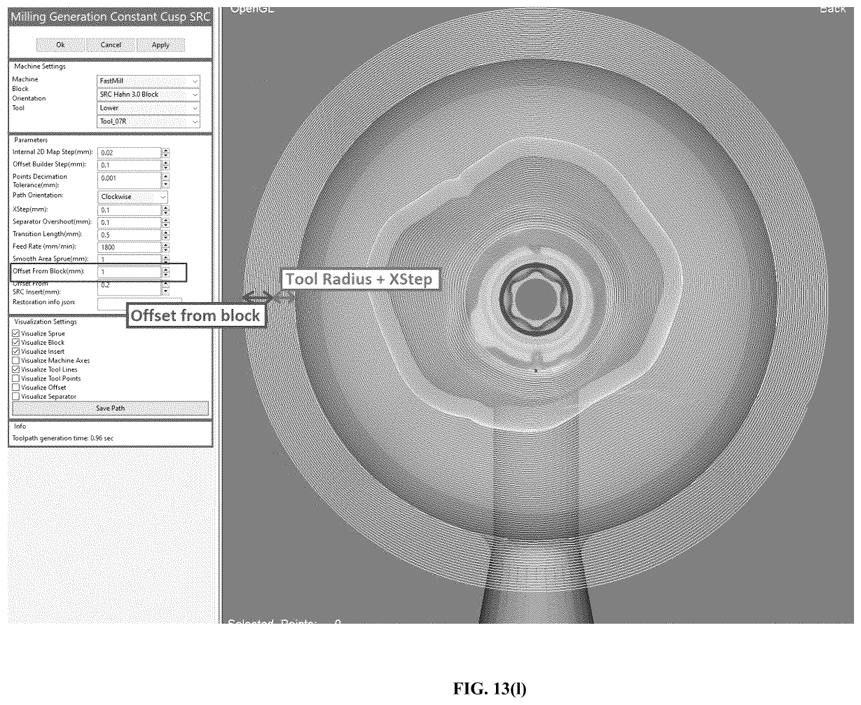

FIG. 13(a) illustrates a screenshot in some embodiments of a virtual restoration design 1302 having a virtual sprue 1304 and a virtual insert model 1306. The virtual restoration design 1302 can be divided by virtual separator 1308 into a lower virtual restoration design region 1310 having the virtual insert receiving region for the virtual insert model 1306 and an upper virtual restoration design region 1312. The virtual separator 1308 can also divide the virtual sprue 1304 into a lower virtual sprue region 1314 and an upper virtual sprue region 1316. The computer-implemented method can generate a lower region virtual toolpath 1318 that includes following the shape of the lower virtual restoration design region 1310 and the lower virtual sprue region 1316.

The computer-implemented method can also generate an upper region virtual toolpath for the upper virtual restoration design region and the upper virtual sprue region. FIG. 13(b) illustrates a screenshot in some embodiments of a virtual restoration design 13100 having an occlusal surface 13101. The virtual restoration design 13100 is nested within a virtual preform 13102, which includes a virtual stem 13104 extending from the virtual preform 13102. A virtual sprue is not shown for clarity. A virtual insert model 13106 can be affixed to a lower region of the virtual preform. In some embodiments, the computer-implemented method can generate an upper region virtual toolpath 13108 for the occlusal surface 13101 of the virtual restoration design 13100 and the upper virtual sprue region (not shown). In some embodiments, the upper region virtual toolpath 13108 can also avoid a virtual screw receiving region opening 13110.

In some embodiments, the lower region and upper virtual toolpaths can be two separate constant cusp toolpaths. A constant cusp tool path can include a single virtual spiral toolpath along an outer 3 dimensional surface (such as a mesh) of the virtual restoration design with approximately the same distance between spirals/circles. In some embodiments, the spiral/circular lines can start from the outside of a virtual preform with a virtual insert model and move (spiral) to the inside of the virtual preform, such as toward the center or other inside region of the virtual preform, for example.

In some embodiments, the upper region virtual toolpath can avoid the virtual screw receiving region opening. This can prevent the milling/grinding tool from entering into the virtual screw receiving region. The lower region virtual toolpath can, in some embodiments, avoid the virtual insert model. The virtual preform with the affixed virtual insert model can represent the physical sintered preform with an affixed physical insert that will be milled. Because the physical insert is made of a metal such as titanium or other metal/substance, it can be desirable to avoid or minimize contact with the milling/grinding tool to prevent damage and/or premature wear and tear. Accordingly, the virtual toolpaths can be constructed to avoid contact with the virtual insert model so that the milling/grinding tool will not contact the physical insert during milling of the physical sintered preform in some embodiments.

In some embodiments, the lower region virtual toolpath can also include a lower portion of the virtual sprue. For example, the lower region virtual toolpath can provide a milling path for the bottom portion of the virtual sprue. In some embodiments, the upper region virtual toolpath can also include a upper portion of the virtual sprue. For example, the upper region virtual toolpath can provide a milling path for the upper portion of the virtual sprue.

FIG. 13(c) shows a screenshot of a graphic representation of a lower virtual restoration design region 1319 of a virtual restoration design 1320 with virtual insert model 1322 and a lower virtual sprue region 1324 of a virtual sprue 1323. A lower region virtual toolpath 1321 is also shown to conform to the 3 dimensional shape of the lower virtual restoration design region 1319 and the lower virtual sprue region 1324. As can be seen from the figure, the lower region virtual toolpath 1321 does not include or extend to the virtual insert model 1322. Rather, the lower region virtual toolpath ends with the final loop/spiral 1326. The lower region virtual toolpath can begin with an outer loop 1325 and finish with an inner loop 1326.

In some embodiments, the one or more virtual toolpaths can be determined based on one or more constant cusp parameters. In some embodiments the one or more constant cusp parameters can include user-configurable values of milling machine, milling/grinding tool, dental implant system type (for the preform/block), and orientation. The milling machine can be a FastMill™ by Glidwell Dental Laboratories or any other type of milling machine. The dental implant system type can be an SRC Hahn 3.0 Block, SRC Hahn 3.5 Block, or any other dental implant system types (preforms/blocks) including but not limited to any described herein. The orientation can be selected between a lower region and an upper region, for example, which are divided by a virtual separator.

As shown in FIG. 13(c), the one or more constant cusp parameters can be adjusted via a graphical user interface panel (“GUI”), such as GUI panel 1328. The one or more constant cusp parameters can affect the one or more virtual toolpaths generated. As shown in the figure, the orientation is selected for the lower region, thereby generating the lower region virtual toolpath 1321. In the figure, since the block or dental implant system type chosen is the SRC Hahn 3.0 Block, the virtual insert model 1322 chosen is for that block. Other dental implant system types/block types can be selected.

In some embodiments, selection of the milling/grinding tool can automatically define a constant cusp parameter of a tool radius that is specific to the mill/milling system selected by the user. The tool radius can be the radius of the tip of the cutting/grinding tool. In some embodiments, the one or more virtual spiral toolpaths can define a virtual path of the tool tip, so that milling/grinding can be performed by a side of the cutting/grinding tool instead of the tip.

In some embodiments the one or more constant cusp parameters can include a virtual sprue point to set an x, y, z position of virtual sprue. In some embodiments the virtual sprue point can be determined from nesting. The one or more constant cusp parameters can also include a pathname for an output file. In some embodiments the one or more constant cusp parameters can include a feed for a speed of the milling/grinding tool in millimeters per minute. In some embodiments the feed can be constant for the one or more virtual toolpaths. In some embodiments the feed can be constant for the one or more toolpaths for the virtual restoration design. In some embodiments the feed can be constant for the one or more toolpaths for the virtual sprue. In some embodiments, the feed rate can be in the range from 6500 mm/min to 8000 mm/min, including the end points of the range. Other suitable feed rates can be utilized.

In some embodiments, the one or more constant cusp parameters can include a user-configurable value that sets a distance between the one or more spirals/circles of the virtual toolpath. The distance value can be specified in millimeters in some embodiments, and can be referred to as Xstep. Increasing the value of Xstep can result in more space between the spiral/circular virtual toolpaths, thereby decreasing milling resolution, while a smaller value of Xstep can provide less space between the spiral/circular virtual toolpaths, thereby increasing the milling resolution. In some embodiments, the distance between the one or more spirals/circles of the virtual toolpaths is a constant/the same. In some embodiments, the distance between the one or more spirals/circles of the lower region virtual toolpath and the upper region virtual toolpath of virtual restoration design is constant/the same. In some embodiments, the value of the distance between the one or more spirals/circles (XStep) can be in the range of from 0.006 mm to 0.012 mm, including the end points of the range. Other suitable values of XStep can be used.

FIG. 13(c) illustrates the distance between the one or more spirals/circles of the lower region virtual toolpath 1321. A distance between spirals/loops/circles 1330 can be constant in three dimensions.

In some embodiments, one or more constant cusp parameters can include a user-configurable buffer offset from the virtual insert model. The buffer offset can be referred to as a OffsetFromSrclnsert value. In some embodiments, the buffer offset from the virtual insert model can be a radius or distance from an outer edge of the virtual insert model in millimeters. The buffer offset from the virtual instant constant cusp parameter can allow a user to create a buffer region between the virtual insert model and the last milling spiral. During milling, the milling/grinding tool can avoid milling within the buffer region radius around the insert in addition to avoiding milling the insert. In some embodiments, the final loop/spiral can be determined as the Tool Radius+OffsetFromSrclnsert distance from the virtual insert model.

FIG. 13(c) illustrates an offset buffer 1332 region between the virtual insert model 1322 and the final loop/spiral 1326 of the lower region virtual toolpath 1321. In some embodiments, the final loop/spiral 1326 can be a distance of the toolradius+OffsetFromSrclnsert value.

In some embodiments, a first spiral line of the Constant Cusp virtual toolpath can be determined as a first loop offset distance from a virtual preform edge. In some embodiments, the first loop offset distance can be ToolRadius+XStep from the virtual preform edge.

FIG. 13(d) illustrates an example of a virtual restoration design 1352 with a virtual stem 1356 nested within a virtual preform 1354 having a virtual screw receiving region 1355 a virtual insert model 1358. A lower region virtual toolpath 1360 can have a first loop/spiral 1362 that is a first loop offset distance from a virtual preform edge 1364. This can be, in some embodiments, a tool radius+Xstep distance from the virtual preform edge 1364.

In some embodiments the one or more constant cusp parameters can include a map step to raise a virtual toolpath above the virtual sprue smoothly. The virtual toolpath can be the lower region virtual toolpath or the upper region virtual toolpath. The map step can be specified in millimeters. The map step can influence how the computer-implemented method slices the 3D model to map the surface and value is distance between the slices. The value of the map step can be any suitable value to provide the desired smoothness of the virtual toolpath transition over the virtual sprue. A smaller map step value can provide a smoother transition over the virtual sprue. A higher map step value can provide a more rough virtual toolpath transition over the virtual sprue. FIG. 13(e) illustrates an example of a lower map step value. As can be seen, the virtual toolpath 1362 over the virtual sprue is smoother and closer to the virtual sprue 1361 than the virtual toolpath 1364 over the virtual sprue 1365 in FIG. 13(f).

In some embodiments the one or more constant cusp parameters can include an offset builder step to define a voxel size. In some embodiments the offset builder step parameter affects offset surface accuracy (and milling accuracy). In some embodiments the offset builder step parameter can be specified in millimeters. A smaller offset builder step parameter value can provide more surface accuracy of the virtual restoration design. In some embodiments a smaller offset builder step parameter value uses more calculation and memory consumption. In some embodiments, a larger voxel size provides less surface accuracy, and the virtual toolpath generated for the virtual restoration design surface can be less accurate. The value of the offset builder can be any suitable value to provide the desired smooth virtual restoration design surface (and corresponding milled restoration surface) within a desired time period and for a desired file size. FIG. 13(g) illustrates an example of a smaller offset builder step parameter value, resulting in a smoother virtual restoration design surface 1370. FIG. 13(h) illustrates an example of a larger offset builder step parameter value, resulting in a more pixelated virtual restoration design surface 1372.

In some embodiments the one or more constant cusp parameters can include a decimation tolerance to provide an ability to adjust a number of points in the one or more virtual toolpaths. In some embodiments, a smaller decimation tolerance means more points on the toolpath. This can provide a more accurate milling of the restoration. A greater decimation tolerance means fewer points on the toolpath. This can speed up milling, but come at the expense of detail. In some embodiments the decimation tolerance allows adjusting an output file size. In some embodiments if several points comprise a line within a given decimation tolerance, all intermediate points are removed. In some embodiments the decimation tolerance can be measured in millimeters. In some embodiments the decimation tolerance must be less than X step. In some embodiments the decimation tolerance parameter value larger than X step significantly distorts isolines of the virtual toolpath. The value of the decimation tolerance can be any suitable value to define the number of points in the toolpath and therefore the output file size. FIG. 13(i) illustrates an example of a larger decimation tolerance, thereby producing fewer points on the virtual toolpath 1376 compared to a smaller decimation tolerance shown in FIG. 13(j), thereby producing more points on the virtual toolpath 1378.

In some embodiments the one or more constant cusp parameters comprise a circle orientation that allows choosing between clockwise rotation and counter clockwise rotation. In some embodiments the circle orientation can be set as “CW” for clockwise or “CCW” for counter clockwise rotation.

In some embodiments the one or more constant cusp parameters can include Z-step to define a vertical distance along the Z axis from a lower region (virtual insert receiving region) of the virtual restoration design toward the virtual separator of the virtual restoration design between milling layers. The Z axis can run along the central axis of the virtual insert model in some embodiments. (See FIG. 11(a)). In some embodiments if Z step differs from X step by more than 10%, then the virtual isolines of the virtual toolpath will be closer/farther from one another along the Z axis. In some embodiments a greater X step than Z step by 10% will bring consecutive virtual isolines along the z-axis closer. In some embodiments, the Z-step parameter is set to the same value as the XStep parameter. Accordingly, in some embodiments, the Z-step parameter can be in the range from 0.006 mm to 0.012 mm, including the end point values. However, other Z-step values can be used as necessary and determined by the user.

In some embodiments the one or more constant cusp parameters can include a transition length. In some embodiments the transition length parameter can include a distance of transition from one loop to the next loop. The transition length parameter can determine a virtual transition region in the one or more virtual toolpaths. The virtual transition region can correspond to a physical transition region of the milling/grinding tool during milling. The virtual transition region can in some embodiments transition the virtual toolpath from one loop or spiral to the next. In some embodiments the transition length parameter can be in millimeters. In some embodiments a transition path can include a path angle defined by: a tan[(Xstep) (transition length)]. In some embodiments a transition length parameter value of zero directs a tool to the next loop in the shortest path. In some embodiments the shortest path can be 90 degrees. FIG. 13(k) illustrates an example of transition length parameter resulting in a transition region 1379.

In some embodiments the one or more constant cusp parameters can include a separator overshoot that defines how much of a tool sphere center can go beyond the virtual separator to make sure the surface can be milled well near virtual separator line. In some embodiments the separator overshoot parameter can be measured in millimeters.

In some embodiments the one or more constant cusp parameters can include an offset from preform parameter to define a distance from a first circle to a preform wall. In some embodiments the offset from preform parameter can be an offset from the preform wall in the Oxy plane. In some embodiments an offset from preform parameter value of 0 mm means the distance from the first circle to the preform wall can be (Tool Radius+x step) to begin milling exactly outside of the preform. In some embodiments a distance from a first isoline to the preform=(tool radius+x step+offset from preform). In some embodiments the offset from preform parameter can be measured in millimeters. FIG. 13(1) illustrates an example of an offset from the preform/block parameter and its application to the virtual toolpath.

In some embodiments the one or more constant cusp parameters can include a near sprue area parameter that defines a distance before and after a sprue. This can be used in some embodiments so that the toolpath approaches the sprue with a smooth radius starting a distance before/after the sprue.

Some embodiments can include an additional virtual sprue reduction toolpath to reduce the diameter of the virtual sprue where it connects to the virtual restoration design. This can advantageously facilitate detaching the physical sprue from the physical restoration design by reducing the amount of material present. The virtual sprue reduction toolpath can be in addition to the lower region virtual toolpath and the upper region virtual toolpath. Accordingly, the one or more virtual toolpaths can include three virtual toolpaths. In some embodiments, the sprue reduction path can be milled after milling the lower region toolpath and the upper region toolpath (i.e. the sprue reduction can be performed last).

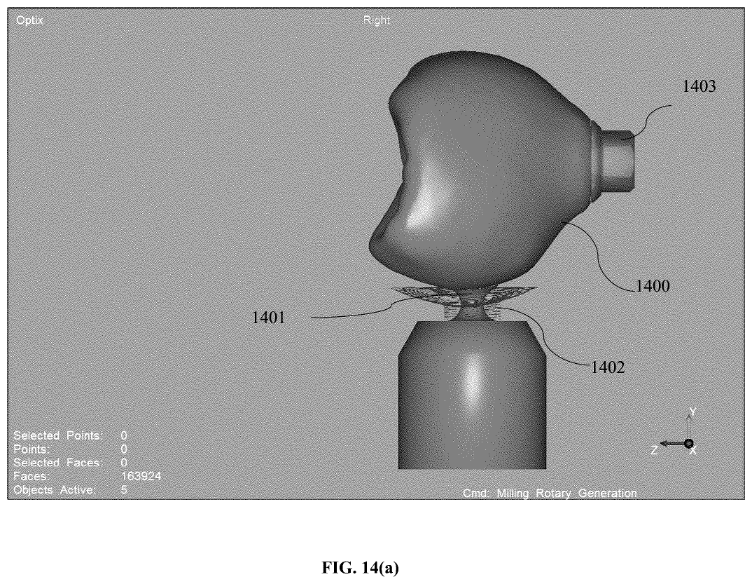

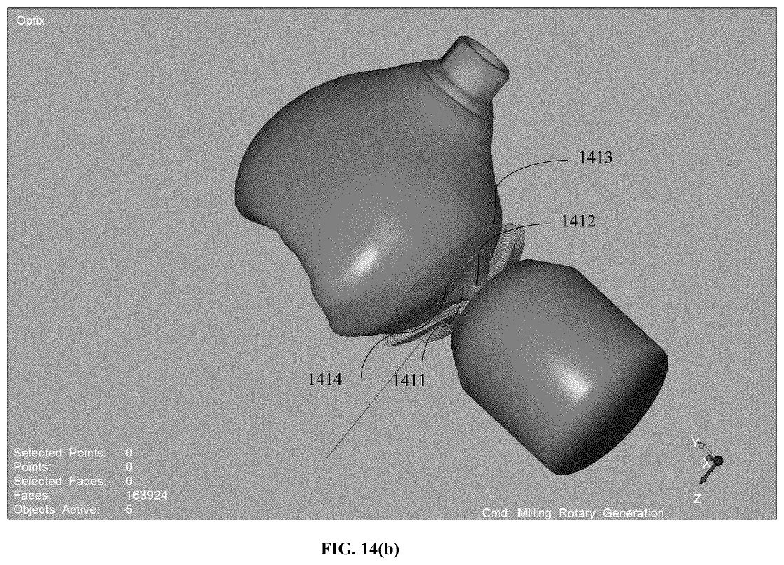

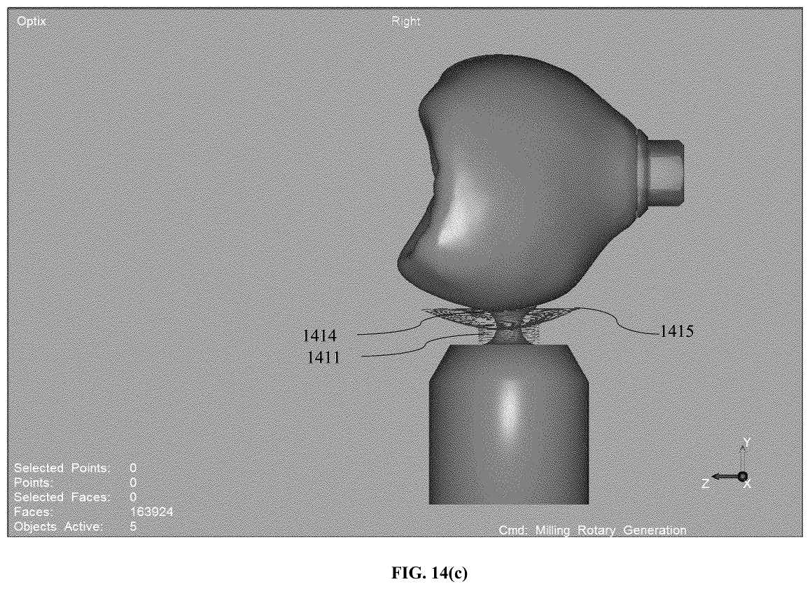

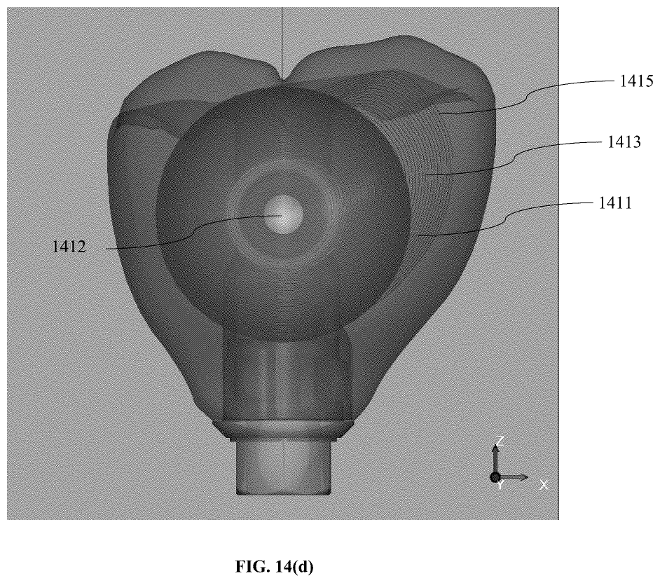

In some embodiments, the virtual sprue reduction toolpath can be a virtual rotary milling toolpath. The sprue diameter can be reduced using a rotary milling toolpath. FIG. 14(a) illustrates an example a virtual sprue reduction toolpath. The sprue reduction toolpath can reduce the diameter of a virtual sprue connected to a virtual restoration design at a sprue connection region between the virtual sprue and the virtual restoration design 1400. As exemplified and illustrated in FIG. 14(a), the virtual rotary tool path around a virtual first stem end 1401 adjacent the virtual dental restoration 1400 having a virtual insert 1403 reduces the stem diameter to enable the restoration to be snapped off the stem by hand or by a handheld tool. In one embodiment, machining steps comprising a rotary tool path 1402 around the stem form a plurality of horizontal slices that are perpendicular to the length axis of the stem. The distance of the tool path boundary from the stem may increase where the stem attaches to the restoration on an angled surface of the restoration.

In some embodiments as illustrated in FIGS. 14(a) and 14(b), a rotary tool path 1411 is provided wherein rotary movement of the milling tool around the stem 1412 is synchronized with movement of the tool in the Y-axis direction. To reduce the size of the tool path boundary, a rotary tool path is provided where as the tool rotates around the stem, Y-axis direction tool path movement 1414 simultaneously follows the restoration surface 1413 that is adjacent the stem. In one embodiment, as illustrated in FIGS. 14(c) and 14(d), a rotary tool path further comprises a containment border 1415, where the boundary of the rotary tool path does not extend past the containment border. The diameter of the containment border 1415 may be calculated as the sum of the diameter of the stem at the surface of the restoration and the radius of the milling tool (for example, 0.5 mm to 1 mm, such as 0.8 mm), and optionally, a tolerance distance may be added to the diameter. The distance of the movement of the tool in the Y-axis direction during a rotation may be increased or decreased so that the boundary of the tool path complies with the containment border.

In some embodiments, the computer-implemented method can generate one or more virtual spiral toolpaths by performing the following in some embodiments:
Step 1: Start outside of the virtual preform
   (a) Determine initial X-Y position (for example as toolradius+Xstep+Offset from block or as any other value) and/or based on one or more constant cusp parameters. Any X-Y position outside of the virtual preform can be chosen in some embodiments.
   (b) Determine initial Z position corresponding to virtual restoration design, virtual sprue, virtual restoration separator, or virtual sprue separator, adjusted based on one or more constant cusp parameters.
Step 2: Determine a virtual loop—repeat the following steps until loop complete
   (a) Determine next X-Y position
      (i) If virtual restoration design or virtual sprue, then follow a contour of the virtual restoration design/virtual sprue, based on one or more constant cusp parameters.
      (ii) Else follow contour of virtual preform based on one or more constant cusp parameters
   (b) Determine next Z position
      (i) If virtual restoration design or virtual sprue, then follow a contour of the virtual restoration design or virtual sprue, based on one or more constant cusp parameters
      (ii) Else follow contour of virtual restoration design separator or virtual sprue separator based on one or more constant cusp parameters
Step 3: If loop complete, perform transition to next loop based on transition length, X Step, Z-step and/or one or more other constant cusp parameters.
Step 4: Repeat steps 2 and 3 until inner most loop completes based on one or more constant cusp parameters.

In some embodiments, the computer-implemented method can perform one or more of the following:
receive a virtual restoration design which in some embodiments can include a virtual screw receiving region and a virtual insert receiving region corresponding to a selected dental implant system;
obtain a virtual preform and a virtual insert model based on the selected dental implant system;
virtually affix the virtual insert model into the virtual insert receiving region;
nest the virtual restoration design within a virtual preform, including selecting placement of a virtual sprue on a side of the virtual restoration design and connecting the virtual sprue a virtual preform stem;
determine a virtual restoration design separator which in some in some embodiments can be a plane through the longest circumference of the virtual restoration design when viewed from the virtual insert model side to divide the virtual restoration design into a first virtual restoration design side and a second virtual restoration design side;
determine a virtual sprue separator which in some embodiments can be a plane through the longest circumference of the virtual sprue when viewed from the virtual insert model side to divide the virtual sprue into a first virtual sprue side and a second virtual sprue side;
generate a first single virtual spiral toolpath corresponding to the shape of the first virtual restoration side and the first virtual sprue side based one or more constant cusp parameters;
generate a second single virtual spiral toolpath following the shape of the second virtual restoration side and the second virtual sprue side based one or more constant cusp parameters;
generate a virtual sprue reduction toolpath to reduce a diameter of the virtual sprue after generating the first and second single virtual spiral toolpaths;
optionally insert a probing sequence into the milling instructions to be performed prior to milling the first and second single virtual spiral toolpaths and the virtual sprue reduction toolpath to determine alignment of a physical preform;
convert the first and second single virtual spiral toolpaths and the virtual sprue reduction toolpath into milling instructions via CAM.

In some embodiments, the virtual restoration design, the virtual preform, the virtual insert model, the virtual sprue, the first and second virtual restoration design sides, the first and second virtual sprue sides, the first and second single virtual spiral toolpaths, and the virtual sprue reduction toolpaths are all three dimensional models that can be viewed and manipulated in a CAD environment.

In some embodiments, the physical preform is a sintered preform having a screw receiving region corresponding to the virtual screw receiving region, an insert receiving region corresponding to the virtual insert receiving region, and a physical insert affixed to the insert receiving region.

In some embodiments, each of the one or more virtual toolpaths correspond to physical toolpaths, and are converted into computer numerical control (“CNC”) code such as G code or other type of code to provide milling instructions to the mill. The conversion can be performed by the CAD/CAM software in some embodiments. The CAM system can take a standard CAD input such as stl or iges of a virtual dental restoration that can also optionally include a virtual sprue and/or one or more other features optionally and create manufacturing instructions which are sent wirelessly or through a wired connection to a computer with a display and input devices such as a tablet PC for example, which forms the human-to-machine interface or HMI for the machine. The HMI communicates with a CNC controller that converts these instructions to real time motion commands. These commands move multiple axes creating relative motion between a spindle and blank piece of material which allows the piece to be cut into a finished dental restoration. In some embodiments, positional data of the nested restoration design may be provided to the CAM system to calculate tool paths from machining strategies. In some embodiments the physical restoration corresponds to the virtual restoration design. In some embodiments each of the one or more virtual toolpaths each correspond to a milling/grinding toolpath. An example of milling can be found in US Pat. Pub. No. 20210128272, the entirety of which is incorporated reference herein. Another example of milling can be found in U.S. Pat. No. 10,258,440, the entirety of which is incorporated by reference herein. An example of a method of making dental restorations from sintered preforms can be found in U.S. patent Ser. No. 10/258,440 to Leeson et. al, the entirety of which is incorporated by reference herein. A method of making anterior dental restorations from sintered preforms can be found in U.S. patent Ser. No. 11/564,773 to Jakoda, et. al, the entirety of which is incorporated by reference herein.

The instructions can direct a milling machine to shape/grind/mill along the one or more physical toolpaths corresponding to the one or more virtual toolpaths. In some embodiments the one or more physical toolpaths comprise spiral helical toolpaths. In some embodiments the spiral helix toolpath can include continuous “uphill” machining. In some embodiments the one or more virtual toolpaths can include grinding SRR restorations. Accordingly, in some embodiments, the virtual lower virtual toolpath, the virtual upper virtual toolpath, and the virtual sprue reduction paths can each be converted by CAD/CAM software and each correspond to physical toolpaths taken by the shape/grind/milling tool during milling. In some embodiments, the CNC code can be stored in a NC file.

### Milling Restoration

In some embodiments, the sintered preform with the pre-affixed insert can be shaped chairside into a final dental restoration, such as a crown or other restoration, that has sufficient material hardness and strength for insertion directly into the mouth of a patient without requiring sintering after shaping. In further embodiments, methods are provided for generating machining instructions corresponding to the one or more virtual toolpaths to shape/grind/mill a physical dental restoration from the millable physical preform in CAD/CAM-based systems. In some embodiments the physical preform can correspond to the virtual preform and can be a sintered preform. In some embodiments, the physical preform can include a screw receiving region and an insert receiving region. In some embodiments, the physical preform can include an pre-affixed physical insert as described in this disclosure in the insert receiving region. The shape/grind/mill can be a chairside shape/grind/mill in some embodiments, such as, for example FastMill™ by Glidewell Dental Laboratories. Chairside mills can be mills suitable for a dental office or other smaller scale facility compared to a dental laboratory. Milling machines, such as chairside mills suitable for milling the sintered preform into a final dental component have at least 3 axes, such as a 3+1 axis CNC machine. A suitable chairside milling machine includes, but is not limited to the TS150™ chairside milling system (IOS Technologies, San Diego, Calif.), or a milling machine as described in commonly owned U.S. Pat. No. 10,133,244, which is incorporated by reference herein in its entirety. In some embodiments, the shape/grind/mill can be any dental shape/grind/mill used to mill dental restorations, including but not limited to those found in dental offices, dental laboratories, or other milling facilities.

### Milling/Grinding Tool

Dental restorations may be shaped by grinding tools instead of traditional milling/grinding tools that are unsuitable for shaping detailed dental restorations from materials having high hardness values. A grinding tool 1500 for example as illustrated in FIG. 15, comprises a shank 1501 that comprises an embedded diamond coating 1503 on the shank and tip 1502. Diamonds suitable for use herein include blocky or friable diamonds having an average size in the range of about 90 micron to about 250 micron, or an average size in the range of about 107 micron to about 250 micron, or an average size in the range of about 120 micron to about 250 micron, or for example, an average size in the range of about 120 micron to about 180 micron. Suitable diamond coatings include those with diamonds embedded by a metal alloy layer for more than half the average height of the diamond, for example, as determined by SEM analysis. In some embodiments, grinding tools have a diamond coated shank having a metal alloy layer having thickness that is greater than about 50%, or greater than about 60%, or greater than about 70%, or greater than about 80%, or between about 60% and 90%, of the average diamond height. Grinding tools having a coating of diamonds that are embedded to a depth of about 50% to 95% of the average diamond size or height, or about 60% to about 95% of the average height of the diamond, or about 80% to about 90% of the height of the diamond height are useful for shaping machinable preforms, such as fully sintered zirconia preforms, having the hardness values described herein. In some embodiments, a grinding tool has a diamond coated shank comprising an average diamond grit size in the range of 126 grit to 181 grit, and a nickel alloy layer having a thickness that is greater than or equal to about 70% of the average diamond height.

A kit is provided for forming a dental restoration that comprises a grinding tool and a machinable sintered preform, wherein the sintered preform material has suitable strength and hardness values for use as an SRR without the need for post-shaping treatment to modify strength properties of the SRR that is shaped from it. The single grinding tool may be used to shape the preform body into a final dental restoration, and the grinding tool comprises a diamond-coated shank comprising diamonds with an average size in the range of 107 micron to 250 micron, embedded in a metal alloy layer having a thickness that is in the range of about 60% to 95% of the diamond height. In some embodiments, the sintered preform body comprises a pre-shaded material that has been selected, for example, to match existing dentition or a shade guide color, and requires no post-shaping coloring or sintering.

In some embodiments, the sintered preform may be secured within a milling machine by fastening the preform to a mandrel. In one embodiment illustrated in FIG. 16, a sintered preform comprising a millable body 1600, a sintered preform stem 1602, an insert receiving region 1608, and a screw receiving region 1610 can be removably attached to an attaching member 1603 for attaching the preform to a mandrel 1604. In some embodiments, a physical insert 1612 can be pre-affixed to the insert receiving region 1608. The attaching member 1603 may be shaped as a rectangle, circle, or square, having a substantially flat surface for adhesive attachment to a mandrel. The mandrel 1604 may be secured within a milling machine with a locking mechanism 1605, such as locking pin and hole elements.

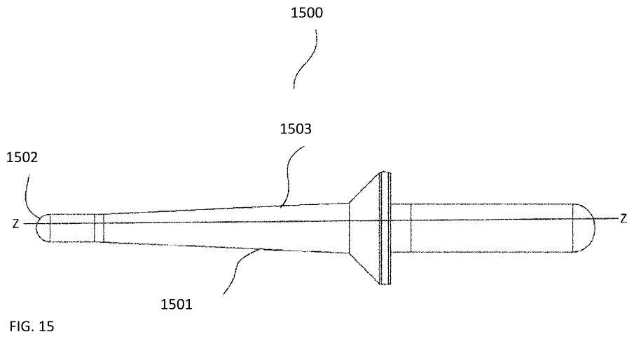

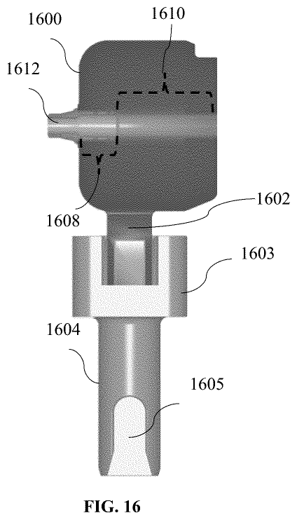

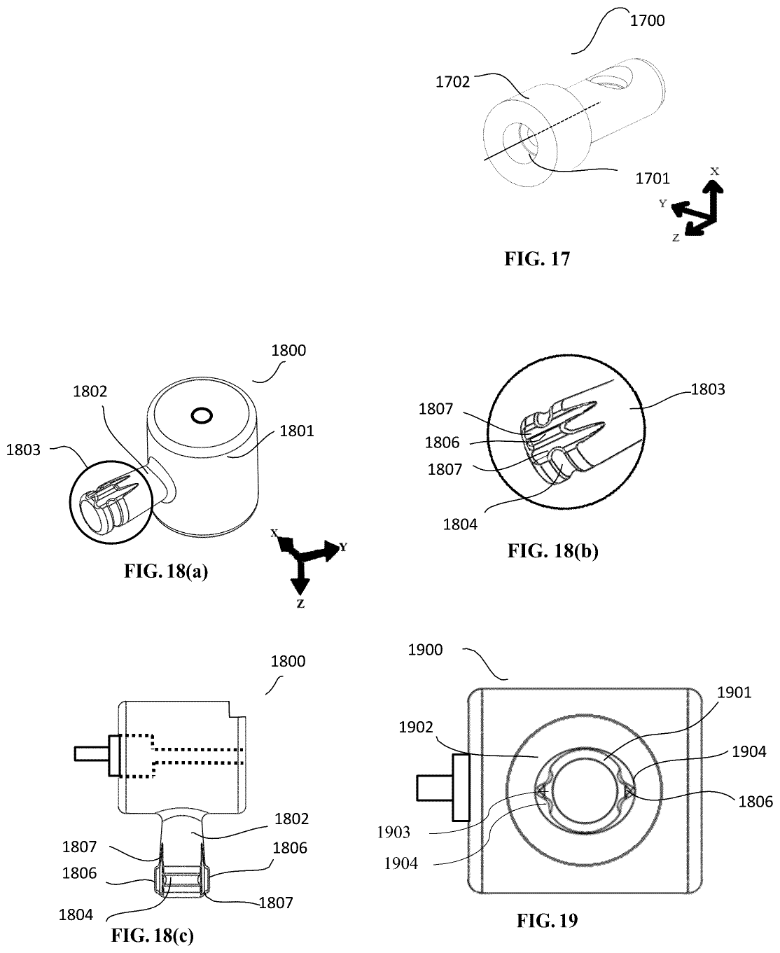

In a further embodiment illustrated in FIGS. 17, 18(a), 18(b), 18(c), 19, and, the preform stem is inserted into a mandrel 1700 through a hole 1701 on the top portion 1702 of the mandrel, and secured, for example, by an interference fit, such as a press or friction fit, adhesive or mechanical locking mechanism. In some embodiments of a preform 1800, the preform body 1801 is attached to a preform stem 1802 having a second stem end 1803 that comprises at least one groove 1804, at least one ridge 1806, or both, on the outer surface of the second stem end 1803, for attachment to a mating end of the mandrel. The groove 1804 and/or ridge 1806 may engage with a complementary convex or convex surface feature on the inner surface of the mandrel to form a locking mechanism. In an alternative embodiment, the at least one ridge 1806 is comprised of sintered zirconia cuts or depresses the inner surface of a mandrel made from a softer material, such as a polymer (e.g., nylon) forming an anti-rotational press fit connection.

In a further embodiment, attachment between the preform stem and the mandrel may be strengthened by the addition of an adhesive. Optionally, surface features, such as one or more channels 1807 or grooves 1804, are milled into the stem to hold adhesive and increase the bonding surface area of the stem outer surface area. FIG. 19 illustrates a cross-sectional view of an interference fit between the preform stem 1901 engaged within a mandrel 1902 wherein a portion of the mandrel inner surface 1904 is deformed by a ridge 1806 forming an anti-rotational fit, and an adhesive connection 1900 comprising an adhesive within stem channels 1807 and within a gap 1903 between the stem 1901 and mandrel 1902. Suitable adhesives include, and are not limited to, light and heat curable adhesive resin, such as a two-part epoxy composition (e.g., UHU® Plus 300, two-part epoxy resin, heavy duty applications, UHU GmbH & Co., Bühl, Germany).

In some embodiments, the milling can be performed on an unsintered preform.

### Detecting Alignment

Some embodiments include a method/computer-implemented method of performing a probing sequence on preform material that has been affixed to the mandrel and placed for milling. In some embodiments, the preform material can be sintered. In some embodiments, the preform material can be unsintered. In some embodiments performing the probing sequence can include using a grinding bur of the mill as a touching probe and utilizing spindle load feedback to detect one or more distances and orientations. The spindle load values used to indicate contact can vary from spindle to spindle and on a given spindle over time (Time-variant system). To account for this, a spindle load sample of the mill running without making contact with anything can be taken as a baseline load in some embodiments. Contact can determined when spindle load goes above a threshold relative to baseline load in some embodiments. This threshold is a mill setting and can be adjusted. In some embodiments, the threshold can be about 0.7% of maximum spindle load in some embodiments. Other suitable threshold values can be used.

In some embodiments the probing sequence can be performed prior to shaping the sintered preform. In some embodiments the probing sequence can include performing multiple touch off points on the preform after loading into the milling machine. The multiple touch off points can provide alignment parameters to correct for positional and/or rotational deviations from a nominal value. The nominal value can be the zero position and rotation for the milling machine. The multiple touch off points can be used to calculate alignment/positional variations of the sintered preform in the milling machine and accounted for by physical correction, and/or setting/updating parameters in the NC file.

Some embodiments provide a method/computer-implemented method of probing the material to determine the position of a center axis of the screw receiving region opening, calculate transformation correction factors, and apply correct milling path relative to the center axis of the screw receiving region opening.

In some embodiments probing sequence can include: with spindle and coolant running, probe 4 points on preform surface to determine the surface plane. Probe center hole (4 points) to determine center of screw. Probe flat on top of preform to determine XY rotation (2 points). Determine XY, ZX, ZY rotations and X,Y offsets to implement transformations.

In some embodiments, the total number of probes can be 10 probes to determine screw orientation relative to machine coordinate system. Probe positions can be used to calculate transformation corrections T made up of rotations and translation (offsets) about each axis (X, Y, and Z). In some embodiments, the computer-implemented method can determine a correction of the y axis and physically adjust the A-axis of the milling machine which corresponds to the y axis. In some embodiments, the computer-implemented method can correct for deviations from the center of the sintered preform by adding to the machine calibration offset (x,y,z coordinates) based on one or more distances from the probed points. In some embodiments, the computer-implemented method can correct X and Z axes deviations by generating one or more transformations using one or more of the distances from the probed points. In some embodiments, the center offset and X and Z offsets can be added to the NC file prior to milling.

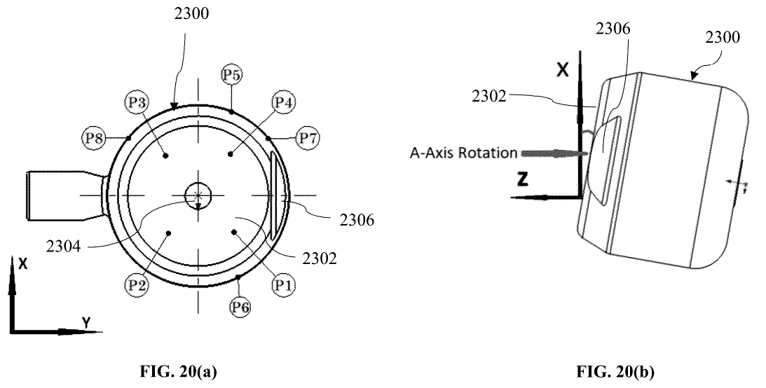

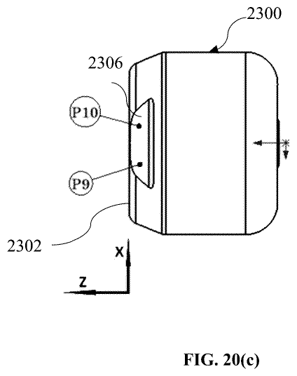

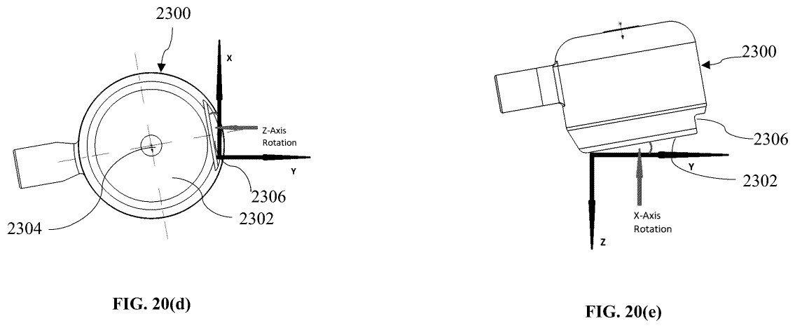

In some embodiments, the probing mechanism is done by using the spindle load (spindle current which is correlated with Spindle load) to determine when contact has been made between the tool and the material. FIG. 20(a) through FIG. 20(e) illustrate probing in some embodiments. Probing can occur along X, Y or Z axis depending on the point being probing. As an example, Probe points P₁, P₂, P₃ and P₄ are along the Z axis. To perform probe P₁, the probe is moved to P_{X1} and P_{Y1} probe position, then moved slowly along Z axis until tool probes material (Determined by load exceeding some threshold). This provides a material position P_{Z1} at position (P_{X1}, P_{Y1}). This can provide point 1 on the surface plane of material at point P₁(P_{X1}, P_{Y1}, P_{Z1}. Similarly, the probe can be moved along X axis to get P₅ and P₆ Y axis to get P₇, P₈, P₉ and P₁₀.

Below is a description of the Process (using right hand rule)
(1) Start SRR Job
(2) M15 in SRR Job NC file Starts SRR Probe and Transformation correction Sequence.
(3) Probe front face 2302 surface Points P₁, P₂, P₃ and P₄ as illustrated in FIG. 20(a) of preform 2300, which can include a screw receiving region opening 2304 and ledge 2306.
(4) Calculate Rotation Correction in Y-axis (same as physical A-axis rotation)

$${θ}_{Y 14} = atan ( \frac{( {P}_{Z 4} - {P}_{Z 1}}{( {P}_{X 4} - {P}_{X 1} )} ) \\ {θ}_{Y 23} = atan ( \frac{( {P}_{Z 3} - {P}_{Z 2}}{( {P}_{X 3} - {P}_{X 2} )} ) \\ {θ}_{A} = {θ}_{Y} \frac{{θ}_{Y 1} + {θ}_{Y 2}}{2}$$

(5) Correct Y-axis rotation, physically move A-axis by correction angle θ_{A} as illustrated in FIG. 20(b), which shows a top view of preform 2300 with front face 2302 and ledge 2306.
(6) Probe outer diameter points P₅, P₆, P₇ and P₈ as illustrated in FIG. 20(a).
(7) Calculate translations (offsets) X₀ and Y₀

$${y}_{0} = \frac{\vert {P}_{Y 8} - {P}_{Y 7} \vert}{2} {X}_{0} = \frac{\vert {P}_{X 5} - {P}_{X 6} \vert}{2}$$

(8) Probe Z-axis Rotation Correction surface points P₉, and P₁₀ as illustrated in FIG. 20(c), which illustrates a top view of preform 2300 with front face 2302 and ledge 2306.
(9) Rotation Correction in Z-axis as illustrated in FIG. 20(d) which illustrates a front view of preform 2300 with front face 2302, screw receiving region opening 2304 and ledge 2306.

$${θ}_{Z} = atan ( \frac{{P}_{Y 10} - {P}_{Y 9}}{{P}_{X 10} - {P}_{X 9}} )$$

(10) Calculate Rotation Correction in X-axis as illustrated in FIG. 20(e), which illustrates a side view of preform 2300 with front face 2302 and ledge 2306.

$${θ}_{X 34} = atan ( \frac{{P}_{Z 3} - {P}_{Z 4}}{{P}_{Y 3} - {P}_{Y 4}} ) \\ {θ}_{X 12} = atan ( \frac{{P}_{Z 2} - {P}_{Z 1}}{{P}_{Y 2} - {P}_{Y 1}} ) \\ {θ}_{X} = \frac{{θ}_{X 12} + {θ}_{X 34}}{2}$$

(11) Calculate translation (offset) Z₀

$${Z}_{0} = \frac{1}{4} {\sum }_{i}^{4} {P}_{Zi} - {θ}_{X} {P}_{Xi} - {θ}_{Y} {P}_{Yi}$$

(12) Create Correction Transformation Matrix with rotations R_{X}(θ_{X}), R_{Z}(θ_{Z}), and translations(offsets)

$$[ \begin{matrix}{X}_{0} \\ {y}_{0} \\ {Z}_{0}\end{matrix} ]$$

$${T}_{correction} = [ \begin{matrix}1 & 0 & 0 & 0 \\ 0 & C {θ}_{x} & - S {θ}_{x} & 0 \\ 0 & S {θ}_{x} & C {θ}_{x} & 0 \\ 0 & 0 & 0 & 1\end{matrix} ] [ \begin{matrix}C {θ}_{Z} & - S {θ}_{Z} & 0 & 0 \\ S {θ}_{Z} & C {θ}_{Z} & 0 & 0 \\ 0 & 0 & 1 & 0 \\ 0 & 0 & 0 & 1\end{matrix} ] [ \begin{matrix}1 & 0 & 0 & {X}_{0} \\ 0 & 1 & 0 & {Y}_{0} \\ 0 & 0 & 1 & {Z}_{0} \\ 0 & 0 & 0 & 1\end{matrix} ] \\ {T}_{correctionFrontFace} = [ \begin{matrix}C {θ}_{x} & - S {θ}_{Z} & 0 & {X}_{0} \\ C {θ}_{x} S {θ}_{Z} & C {θ}_{x} C {θ}_{Z} & - S {θ}_{x} & {Y}_{0} \\ S {θ}_{x} S {θ}_{Z} & S {θ}_{x} C {θ}_{Z} & C {θ}_{x} & {Z}_{0} \\ 0 & 0 & 0 & 1\end{matrix} ] \\ {T}_{correctionBackFace} = [ \begin{matrix}- C {θ}_{x} & S {θ}_{Z} & 0 & {X}_{0}^{′} \\ C {θ}_{x} S {θ}_{Z} & C {θ}_{x} C {θ}_{Z} & - S {θ}_{x} & {Y}_{0}^{′} \\ - S {θ}_{x} S {θ}_{Z} & - S {θ}_{x} C {θ}_{Z} & - C {θ}_{x} & {Z}_{0}^{′} \\ 0 & 0 & 0 & 1\end{matrix} ]$$

$${X}_{0}^{′} = G {54}_{X} ( {X}_{0} - G 5 {4}_{X} ) \\ {Y}_{0}^{′} = {Y}_{0} \\ {Z}_{0}^{′} = G5 {4}_{Z} ( {Z}_{0} - G 5 {4}_{Z} )$$

(13) Continue SRR Job

In some embodiments, X′₀, Y′₀, Z′₀ can be the offsets for the zero position of the center of the screw receiving region opening due to misalignment relative to a mill coordinate system. In some embodiments, the transformations can be applied to the NC file.

### Milling Sintered Restoration

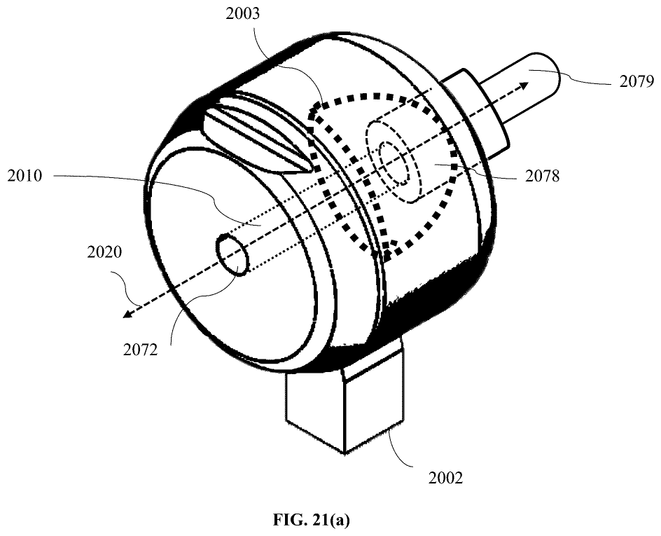

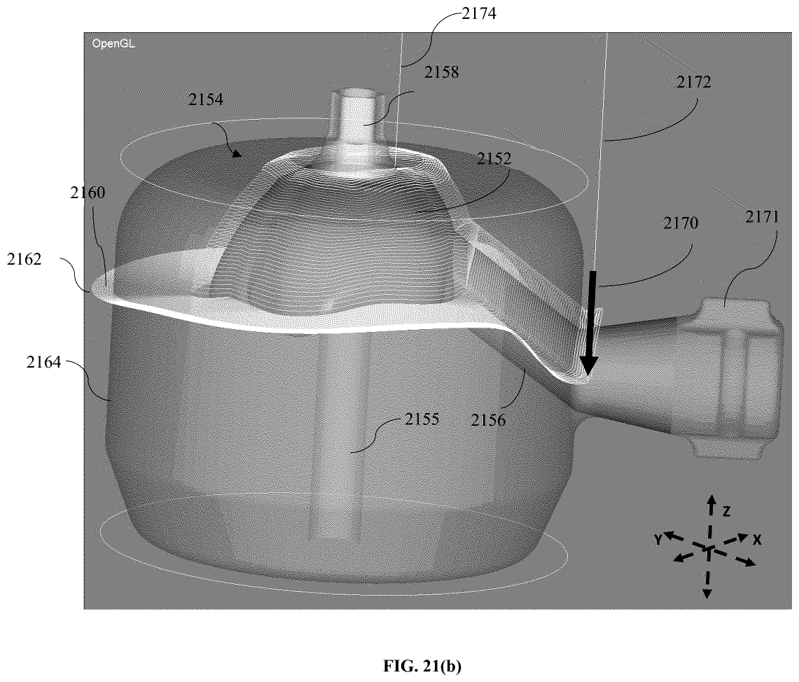

As exemplified in FIG. 21 (a), a dental restoration design 2003 can be arranged at a particular rotational position around an axis 2020 within a model of the preform body to select nesting and placement of the dental restoration design 2003 relative to the preform stem 2002. The position of the stem on the final dental restoration upon shaping the restoration from the machinable preform can be determined by a nesting position.

FIG. 21 (a) illustrates an embodiment in which the shape and size of a preform body 2001 accommodates a restoration design 2003 within the preform body that can be arranged at any rotational position around the z-axis (line Z-Z′) 2020; thus, the preform can include 360 degree (full rotation) stem 2002 placement relative to the final restoration based on the nesting position selected. In some embodiments, the outer diameter of the circular cross-section of the center portion from which the restoration design is shaped can be from about 12 mm to about 20 mm, or from about 13 mm to about 18 mm, or from about 14 mm to about 17 mm in some embodiments. However, other suitable dimensions can be used. In some embodiments, the final restoration design 2003 can include at least a portion of the screw receiving region 2010 with screw receiving region opening 2072 and at least a portion of the insert receiving region 2078 and a physical insert 2079 inserted into the insert receiving region 2078.

FIG. 21 (b) illustrates milling an SRR from a preform in some embodiments. In FIG. 21 (b), a screw retained dental restoration design 2152 with a stem 2156 to be milled from preform 2154 is illustrated as being nested within the preform 2154, which includes a screw receiving region 2155 and an insert 2158. A lower region toolpath 2160 can have a first loop/spiral 2162 that is a first loop offset distance from a physical preform edge 2164. This can be, in some embodiments, a tool radius+Xstep distance from the preform edge 2164. Also shown is a representation of a milling/grinding tool 2170 that can move along the Z axis (positive Z being in a direction into the stem 2156 and negative Z being away from the stem 2156). The preform 2154 can in some embodiments be affixed at the stem 2171 to a mandrel that can be affixed to a portion of the milling machine which can move the preform 2154 in the X-Y plane, for example, and can also provide rotation around the Y axis. Alternatively, in some embodiments, the preform 2154 can remain fixed, and the milling/grinding tool 2170 can move in the X-Y-Z directions. In some embodiments, the milling/grinding tool 2170 can start along a tool insertion path 2172, mill/grind the screw retained dental restoration design 2152 and the stem 2156 along the lower region toolpath 2160, and stop at a tool exit path 2174. In some embodiments, after completing the lower region toolpath 2160 the preform 2154 can be rotated by the milling machine to mill an upper region toolpath in a similar manner. The upper and lower region toolpaths can be milled in any order. In some embodiments, the milling machine can mill a sprue reduction toolpath by rotating the preform 2154 and stem 2156 continuously to reduce a sprue diameter. In some embodiments, the preform can be already sintered.

In some embodiments, a physical screw retained dental restoration (“SRR”) can include a SRR body, an insert receiving region within the SRR body on a base region of the SRR body and a screw receiving region within the SRR body on an opposite end of the base region. In some embodiments, the SRR can be fully sintered. In some embodiments, the physical SRR can also include an attached insert affixed within its insert receiving region. In some embodiments, the SRR can include a sprue.

The insert receiving region within the SRR body can correspond to the virtual insert receiving region of the virtual preform. The base region of the SRR body can include an end opposite the occlusal surface of the SRR body. The insert receiving region can provide a tunnel region within the SRR body, the tunnel region surrounded by SRR body. In some embodiments the insert receiving region can be substantially cylindrical and/or shaped to accommodate a physical insert corresponding to the selected dental implant system type. The screw receiving region within the SRR body can correspond to the virtual screw receiving region of the virtual preform. The SRR can include a physical insert inserted into the insert receiving region. The physical insert can be pre-affixed to the sintered preform from which the SRR is shaped in some embodiments.

In some embodiments the insert receiving region and the screw receiving region are connected together within the SRR body. In some embodiments a diameter of the insert receiving region can be greater than a diameter of the screw receiving region. Some embodiments can further can include a screw, the screw can include a threaded region to interface and lock into an implant system.

In some embodiments the SRR can be a screw retained crown. In some embodiments the SRR can be a screw retained restoration tooth. In some embodiments, the SRR can be any kind of dental restoration.

The SRR can also include a sprue connected to the SRR body. The physical sprue can correspond to the virtual sprue. The sprue can connect to the SRR body in sprue connection region that is not the base (bottom) region of the SRR, nor on the occlusal region of the SRR.

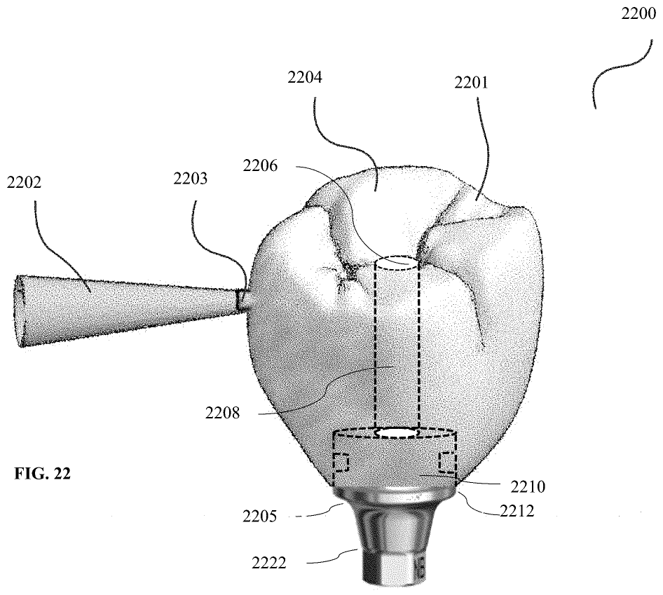

FIG. 22 illustrates a physical sintered SRR 2200 in some embodiments. The length of the preform body between the top end and the bottom end is sufficient to accommodate the height of most dental restoration designs such as physical sintered SRR 2201 when measured, for example, from the highest point of the occlusal surface 2204 to the lowest point on a tooth margin 2205. In some embodiments a sprue 2202 can connect 2203 to the middle of the physical sintered SRR 2201, away from the occlusal surface 2204 and the edge or margin of the physical sintered SRR, as seen in FIG. 22. In some embodiments, the physical sintered SRR 2201 can include screw receiving region 2208 and a screw receiving region opening 2206 and an insert interfacing region 2210 and an insert receiving region opening 2212 and a physical insert 2222 that is inserted into the insert receiving region 2210. The screw receiving region 2208 can provide a channel through the physical sintered SRR 2201 from the screw receiving region opening 2206 to the physical insert 2222.

Some embodiments can include a method of installing a physical sintered screw retained dental restoration. The method can include receiving a physical sintered SRR, placing the physical sintered SRR into an implant system in a patient's dentition, inserting a screw into a screw receiving region of the physical sintered SRR so that the screw passes through the screw receiving region and through a hollow region of the physical insert; and affixing the screw and physical sintered SRR to the implant system. The screw can anchor the insert and therefore the connected SRR to the implant in some embodiments. The method can further can include filling in the screw receiving region with a dental filling material known in the art. In some embodiments, a physical sprue can be cut off or detached from the physical sintered SRR.

In some embodiments placing the physical sintered SRR can include orienting an insert implant connection region of an insert affixed to the physical sintered SRR to connect with an implant analog of the implant system. In some embodiments affixing the screw and physical sintered SRR can include turning the screw to lock one or more threads of the screw with one or more threads of the implant analog.

In some embodiments, one or more virtual elements such as virtual models, virtual toolpaths, etc. described herein can have corresponding physical elements.

One or more advantages of one or more features can include, for example, improvement to functionality of in-office chairside machining by incorporating the ability to produce fully-sintered BruxZir Screw Retained crown restorations directly in the dental office. One or more advantages of one or more features can include, for example allowing the Dental professional to scan, prep, produce and install a patient's Screw Retained Crown all in the same visit using a high quality BruxZir material. One or more advantages of one or more features can include, for example expanding use of the existing BruxZir NOW chairside restorations to support screw retained dental restorations such as Screw Retained Crowns and/or other restorations. One or more advantages of one or more features can include, for example chairside software improvements to generate machine code that utilizes a milling strategy developed and optimized for fully-sintered zirconium material grinding specific to Screw Retained Crown restorations that have no cavity geometry. One or more advantages of one or more features can include, for example providing two 2 spiral toolpaths that can allow for continuous ‘uphill’ machining to greatly improve machining efficiency and cycle-time. One or more advantages of one or more features can include, for example, use of BruxZir NOW material for producing in-office screw retained dental restoration such as a Screw Retained Crown, for example. One or more advantages of one or more features can include, for example allowing dental professionals to provide patients with full strength zirconium Screw Retained Crown restorations in a single-visit service. One or more advantages of one or more features can include, for example that the BruxZir NOW preform pre-form shape can be tailored for screw retained dental restoration units, such as Screw Retained Crowns. One or more advantages of one or more features can include, for example improved milling strategy and toolpath allow milling Screw retained dental restoration units such as Screw Retained Crowns, for example. One or more advantages of one or more features can include, for example a nesting algorithm tailored for Screw retained dental restoration units such as Screw Retained Crowns, for example, to reference the screw access hole and insert orientation for proper alignment of the Restoration within the preform. One or more advantages of one or more features can include, for example specific preform features to facilitate probing and accurate location of the implant connection. One or more advantages of one or more features can include, for example, pre-cemented insert made possible by the fully sintered material that does not need to undergo any heat process post milling enables implant restorations such as crowns, etc. to be directly placed with much less time and labor. One or more advantages of one or more features can include, for example, uphill machining improves machining efficiency and cycle-time. One or more advantages of one or more features can include, for example the spiral toolpath can include using less of milling/grinding tool tip and more of side of milling/grinding tool since the weakest point can be the tip. One or more advantages of one or more features can include, for example, removing minimum material by the tip and moving up in a positive slope, using more of the side of the milling/grinding tool.

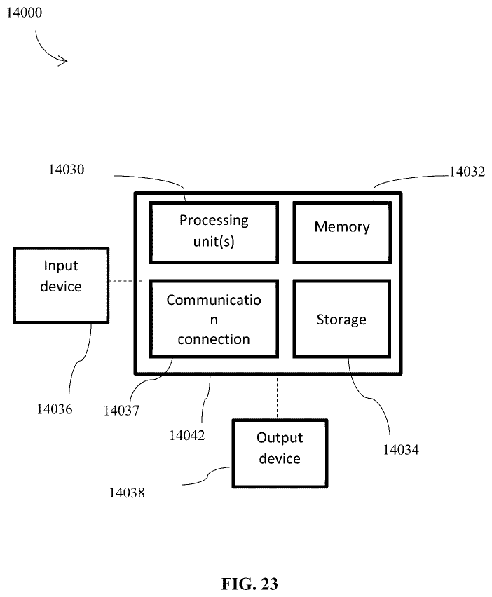

FIG. 23 illustrates a processing system 14000 in some embodiments. The system 14000 can include a processor 14030, computer-readable storage medium 14034 having instructions executable by the processor to perform one or more steps described in the present disclosure. For example, the system can include a processor, a computer-readable storage medium including instructions executable by the processor to perform steps including one or more features in the present disclosure.

Some embodiments can include a computer-implemented method of performing one or more features in the present disclosure.

Some embodiments can include a non-transitory computer readable medium storing executable computer program instructions to provide one or more features in the present disclosure.

Some embodiments can include a system for one or more features in the present disclosure. For example, some embodiments can include a system comprising: a processor; and a non-transitory computer-readable storage medium comprising instructions executable by the processor to perform steps/features in the present disclosure.

In some embodiments, one or more features in the present disclosure can be performed by a user, for example. In some embodiments, one or more features can be performed by a user using an input device to interact with the 3D digital model of the virtual restoration design, the virtual preform, the virtual sprue, and/or the virtual insert model on a display, for example. In some embodiments, the computer-implemented method can allow the input device to manipulate the 3D digital models displayed on the display. For example, in some embodiments, the computer-implemented method can rotate, zoom, move, and/or otherwise manipulate the digital model in any way as is known in the art. In some embodiments, one or more features can be initiated, for example, using techniques known in the art, such as a user selecting another button.

One or more of the features disclosed herein can be performed and/or attained automatically, without manual or user intervention. One or more of the features disclosed herein can be performed by a computer-implemented method. The features-including but not limited to any methods and systems-disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, in some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A physical preform suitable for a screw retained dental restoration (“SRR”), comprising:
a sintered preform; and
an insert receiving region within at least a portion of the sintered preform.

2. The physical preform of claim 1, wherein the sintered preform comprises fully sintered zirconium.

3. The physical preform of claim 1, wherein the insert receiving region is shaped to hold at least a portion of an insert.

4. The physical preform of claim 1, further comprising a screw receiving region within at least a portion of the sintered preform on an opposite end of the insert receiving region.

5. The physical preform of claim 1, wherein the screw receiving region is shaped to allow a screw to pass through the screw receiving region.

6. The physical preform of claim 1, further comprising a physical insert comprising an interfacing portion affixed to at least a portion of the sintered preform in the insert receiving region.

7. A computer-implemented method of providing a screw retained dental restoration, comprising:
receiving a virtual restoration model; and
generating one or more virtual spiral toolpaths corresponding to a virtual restoration shape of the virtual restoration model.

8. The method of claim 7, further comprising virtually nesting the virtual restoration model within a virtual preform.

9. The method of claim 7, further comprising generating a virtual sprue reduction milling/grinding toolpath of the preform.

10. The method of claim 7, wherein virtually nesting comprises:
aligning the virtual restoration model within the virtual preform;
rotating the virtual restoration model into one or more rotational positions around the virtual screw receiving axis; and
determining a virtual sprue location on the virtual restoration model.

11. The method of claim 7, further comprising shaping a physical sintered preform having an attached insert using the one or more spiral toolpaths to provide a physical dental restoration.

12. The method of claim 11 wherein the one or more spiral toolpaths begin from outside the physical sintered preform and move toward center of the physical sintered preform.

13. The method of claim 11, wherein the one or more spiral toolpaths avoid the attached insert.

14. The method of claim 10, wherein a virtual sprue connects at an angle to the virtual restoration model at the virtual sprue location.

15. A computer-implemented method of correcting preform placement during milling, comprising:
probing one or more surface points of a preform mounted to a milling machine using a grinding bur of the milling machine; and
determining one or more preform alignment parameters based on a distance traveled by the grinding bur to the one or more surface points.

16. The method of claim 15, wherein the one or more alignment parameters correct for one or more from the group consisting of positional and axial deviations.

17. The method of claim 15, wherein probing one or more surface points comprises determining a spindle load feedback of the grinding bur.

18. The method of claim 15, wherein the probing is performed prior to shaping the preform.

19. The method of claim 15, further comprising adjusting milling of the preform based on the one or more alignment and positioning parameters.

20. The method of claim 15, further comprising determining X, Y, and Z axis rotations.

21. The method claim 15, further comprising determining an X, Y, and Z offset for zero position.
